(19) United States
(12) Patent Application Publication
(10) Pub. No.: US 2009/0112370 A1
(43) Pub. Date: Apr. 30, 2009

(54) VACUUM SYSTEM AND METHOD FOR OPERATING THE SAME

(75) Inventors: Hiroyuki Tanaka, Tokyo (JP); Kiyoshi Ando, Mie (JP)

Correspondence Address: RATNERPRESTIA, P.O. BOX 980, VALLEY FORGE, PA, 19482, US

(73) Assignees: ASM JAPAN K.K., Tama-shi (JP); NABTESCO CORPORATION, Tokyo (JP)

(21) Appl. No.: 11/996,326

(22) PCT Filed: Jul. 14, 2006
(86) PCT No.: PCT/JP2006/314056

§ 371 Date: Jan. 21, 2008

(30) Foreign Application Priority Data
Jul. 21, 2005 (JP) 2005-211245

(51) Int. Cl. G05D 7/06

(52) U.S. Cl. 700/282

(57) ABSTRACT

The present invention provides a vacuum system including a vacuum pump capable of operating at a rotation rate controlled appropriately when a predetermined process is performed in a vacuum chamber, which contributes to energy conservation. The vacuum system serves as a semiconductor manufacturing system comprising a vacuum pump controller which has a gas flow mode and an auto-tuning mode for determining a rotation rate of a vacuum pump unit to set the rotation rate to a target value lower by a predetermined value than the full operation rate of gas flow rate control means under the condition that pressure within the process chamber is vacuum pressure necessary for the gas flow mode. The vacuum pump controller has means for reducing the rotation rate of the vacuum pump unit from a rated rotation rate in the auto-tuning mode under the condition that pressure within the process chamber is vacuum necessary for the gas flow mode, to determine whether or not the operation rate of an APC valve reaches a target value, and means for storing, as the rotation rate necessary for the gas flow mode, the rotation rate of the vacuum pump unit, which is obtained when it is determined that the operation rate of the APC valve reaches the target value.

### TECHNICAL FIELD OF THE INVENTION

The present invention relates to a vacuum system having a vacuum pump to set a level of pressure within a vacuum chamber to a vacuum pressure level, and a method for operating the vacuum system, which is used in a process for manufacturing a semiconductor, a plasma apparatus and the like.

### BACKGROUND OF THE INVENTION

There has been proposed a vacuum system used in a process for manufacturing a semiconductor and the like. The conventional vacuum system includes a vacuum pump for discharging a gas from a vacuum chamber, gas flow rate control means for controlling the flow rate of a gas to be discharged, and a controller for controlling an operation rate of the gas flow rate control means to set pressure within the vacuum chamber to vacuum pressure appropriate for a predetermined process.

The vacuum pump of the conventional vacuum system is operated at a certain high speed under rated operating conditions. This results from the facts that a contaminant flows back into the vacuum chamber from the outside of the vacuum chamber when the operation of the vacuum pump stops; that it takes a lot of time to set a level of the pressure within the vacuum chamber to a vacuum pressure level, which results in a reduction in the amount of production of semiconductors; and that a process gas is generated and becomes solidified in the vacuum pump in the process for manufacturing a semiconductor, which may adversely affect the operation of the vacuum pump.

It is also known that another conventional vacuum system capable of preventing a vacuum pump from operating at an excessive rotation rate when pressure within a vacuum chamber does not need to be high vacuum, by setting the rotation rate of the vacuum pump, which is obtained when the pressure within the vacuum chamber does not need to be high vacuum, to a value lower than the rotation rate of the vacuum pump, which is obtained when the pressure within the vacuum chamber needs to be high vacuum (refer to, for example, Patent Document 1).

### Patent Document 1: Japanese Patent Laid Open Publication 2003-97428

### DISCLOSURE OF THE INVENTION

### Problems to be Resolved by the Invention

The vacuum system disclosed in Patent Document 1, however, is not capable of preventing the vacuum pump from operating at an excessive rotation rate when the pressure in the vacuum chamber needs to be high vacuum. The rotation rate of the vacuum pump can be reduced by completely closing a valve disposed between the vacuum chamber and the vacuum pump when the pressure within the vacuum chamber does not need to be high vacuum. The rotation rate of the vacuum pump, however, is not necessarily a required minimum rate.

It is, therefore, an object of the present invention to provide a vacuum system capable of maintaining a rotation rate of a vacuum pump when a predetermined process is performed in a vacuum chamber, which contributes to energy conservation.

The vacuum system according to the present invention comprises a vacuum pump for discharging a gas from a vacuum chamber, gas flow rate control means for controlling the flow rate of a gas to be discharged, and a controller for controlling an operation rate of the gas flow rate control means to control pressure within the vacuum chamber to vacuum pressure appropriate for a predetermined process. The controller has a gas flow mode as an operation mode for performing a predetermined process in the vacuum chamber, and an auto-tuning mode for determining the rotation rate of the vacuum pump so as to obtain a target value lower by a predetermined value than the full operation rate of the gas flow rate control means. The vacuum system according to the present invention further comprises determination means for determining whether or not the operation rate of the gas flow rate control means reaches the target value by decreasing the rotation rate of the vacuum pump from a rated rotation rate under the condition that the pressure within the vacuum chamber is set to vacuum pressure necessary for the gas flow mode in the auto-tuning mode, or by increasing the rotation rate of the vacuum pump from a minimum rotation rate sufficient to maintain the vacuum pressure necessary for the gas flow rate. Also, the vacuum system according to the present invention further comprises storage means for storing, as a rotation rate of the vacuum pump for the gas flow mode, the rotation rate of the vacuum pump, which is obtained when the determination means determines the operation rate of the gas flow rate control means reaches the target value.

The vacuum system thus constructed according to the present invention is designed to obtain, in advance, a rotation rate of the vacuum pump, which is appropriate for the gas flow mode, in the auto-tuning mode, and to cause the vacuum pump to operate at a more appropriate rotation rate in the gas flow mode compared with the conventional techniques, which contributes to energy conservation.

The controller of the vacuum system thus constructed according to the present invention further includes: a vacuum mode for setting the pressure within the vacuum chamber to vacuum pressure lower than the pressure within the vacuum chamber in the gas flow mode under the condition that the gas flow rate control means is open. The vacuum system according to the present invention further comprises: determination means for determining whether or not high vacuum pressure can be maintained in the vacuum mode with the vacuum pump operating at the rotation rate for the gas flow mode, which is stored in the storage means, in the auto-tuning mode; means for increasing the rotation rate of the vacuum pump when the determination means determines that high vacuum cannot be maintained; and storage means for storing, as a rotation rate of the vacuum pump for the vacuum mode, the rotation rate being obtained when the determination means determines that high vacuum can be maintained.

The vacuum system thus constructed according to the present invention is designed to obtain, in advance, a rotation rate of the vacuum pump, which is appropriate for the vacuum mode, in the auto-tuning mode, and to cause the vacuum pump to operate at a more appropriate rotation rate for the vacuum mode compared with the conventional techniques, which contributes to energy conservation.

The vacuum system according to the present invention comprises a vacuum pump for discharging a gas from a vacuum chamber, gas flow rate control means for controlling the flow rate of a gas to be discharged, and a controller for controlling an operation rate of the gas flow rate control means to control pressure within the vacuum chamber to vacuum pressure appropriate for a predetermined process. The controller has a gas flow mode as an operation mode used for a predetermined process in the vacuum chamber, a vacuum mode as an operation mode for setting pressure within the vacuum chamber to vacuum pressure lower than the pressure within the vacuum chamber in the gas flow mode, and an auto-tuning mode performed before the abovementioned operation mode and used to determine the rotation rate of the vacuum pump, which allows the pressure within the vacuum chamber to be set to high vacuum pressure necessary for the vacuum mode. The vacuum system further comprises determination means for determining whether or not the pressure within the vacuum chamber reaches a target value of the high vacuum pressure by decreasing the rotation rate of the vacuum pump from a rated rotation rate, or by increasing the rotation rate of the vacuum pump from a minimum operational rotation rate of the vacuum pump, and storage means for storing, as a rotation rate of the vacuum pump for the vacuum mode, the rotation rate of the vacuum pump when the determination means determines that the pressure within the vacuum chamber reaches the target value of the high vacuum pressure.

The vacuum system thus constructed according to the present invention is designed to obtain, in advance, a rotation rate of the vacuum pump, which is appropriate for the vacuum mode, in the auto-tuning mode, and to cause the vacuum pump to operate at a more appropriate rotation rate in the vacuum mode compared with the conventional techniques, which contributes to energy conservation.

The controller of the vacuum system according to the present invention includes determining means for determining whether or not the operation rate of the gas flow rate control means is lower than a target value set in advance when the controller controls the gas flow rate control means to set the pressure within the vacuum chamber to vacuum pressure in gas flow mode with the vacuum pump operating at the rotation rate for the vacuum mode, which is stored in the storage means, means for increasing the rotation rate of the vacuum pump when the determining means determines that the operation rate of the gas flow rate control means is lower than the target value set in advance, and means for storing, as a rotation rate of the vacuum pump for the gas flow mode, the rotation rate of the vacuum pump which is obtained when the determining means determines that the operation rate of the gas flow rate control means is equal to or higher than a target value set in advance.

The vacuum system thus constructed according to the present invention is designed to obtain, in advance, a rotation rate of the vacuum pump, which is appropriate for the gas flow mode, in the auto-tuning mode, and to cause the vacuum pump to operate at a more appropriate rotation rate for the gas flow mode compared with the conventional techniques, which contributes to energy conservation.

The controller of the vacuum system according to the present invention is designed to cause the vacuum pump to operate at a higher one of the rotation rate of the vacuum pump for the gas flow mode and the rotation rate of the vacuum pump for the vacuum mode, which are calculated in the auto-tuning mode.

The vacuum system thus constructed according to the present invention is capable of controlling pressure within the vacuum chamber with stability since the rotation rate of the vacuum pump does not need to change when a change between the gas flow mode and the vacuum mode is made.

The vacuum system according to the present invention is designed so that a target value of the operation rate of the gas flow rate control means is set to a range causing a relatively small ratio of a change in pressure within the vacuum chamber with respect to a change in operation rate of the gas flow rate control means is relatively small.

The vacuum system thus constructed according to the present invention is capable of finely controlling the operation rate of the gas flow rate control means to control a variation in pressure within the vacuum chamber.

The present invention provides a method for operating the vacuum system that evacuates a vacuum chamber by use of a vacuum pump and controls a closing degree of the gas flow rate control means, which determines the flow rate of a gas, to control a flow rate of a gas and to thereby control pressure within the vacuum chamber to a predetermined value, the vacuum system having operation modes including a gas flow mode for performing a vacuum process in the vacuum chamber and an auto-tuning mode for searching a rotation rate of the vacuum pump in the operation mode, the auto-tuning mode being performed before the operation mode, wherein the auto-tuning mode comprises the steps of: setting a target value of pressure within the vacuum chamber for the gas flow mode and a target value of the closing degree of the gas flow rate control means, which determines the flow rate of a gas, to control the flow rate of the gas; increasing the rotation rate of the vacuum pump from a minimum rotation rate allowing pressure within the vacuum chamber to be maintained to the target value of pressure within the vacuum chamber for the gas flow mode or decreasing the rotation rate of the vacuum pump from a rated rotation rate; determining whether or not the operation rate reaches the target value of the operation rate; and storing a rotation rate of the vacuum pump when the operation rate reaches the target value of the operation rate.

The method as described above according to the present invention is performed to obtain, in advance, a rotation rate of the vacuum pump, which is appropriate for the gas flow mode, in the auto-tuning mode, and to cause the vacuum pump to operate at a more appropriate rotation rate for the gas flow mode compared with the conventional techniques, which contributes to energy conservation.

The vacuum system according to the present invention preferably further comprises: means for determining whether or not vacuum pressure within the vacuum chamber can be maintained, and/or means for determining whether or not an operation rate of the gas flow rate control means reaches the target value of the operation rate; at least one of means whether or not power consumed by the vacuum pump is reduced, means for determining whether or not a current consumed by the vacuum pump is reduced, and means for determining whether or not a temperature of the vacuum pump is equal to or higher than, or equal to or lower than a predetermined value; and means for storing, as a rotation rate of the vacuum pump for the gas flow mode or for the vacuum mode, the rotation of the vacuum pump which is obtained based on determination of the at least one of means.

The vacuum system thus constructed according to the present invention is capable of storing a minimum rotation rate necessary for the gas flow mode, which is obtained when the rotation rate of the vacuum pump changes from its decreasing state to its increasing state in order to maintain the pressure within the vacuum chamber to a target vacuum pressure necessary for the gas flow mode and of obtaining, in advance, a rotation rate of the vacuum pump, which is close to a required minimum rotation rate. The vacuum system, therefore, can contribute to energy conservation.

The method for operating the vacuum system, according to the present invention, preferably further comprises: a step of determining whether or not an operation rate of the gas flow rate control means reaches a target value of the operation rate; at least one of a step of determining whether or not pressure within the vacuum chamber is maintained to predetermined high vacuum, a step of determining whether or not power consumed by the vacuum pump is reduced, a step of determining whether or not a current consumed by the vacuum pump is reduced, and a step of determining whether or not a temperature of the vacuum pump is equal to or higher than (lower than) a predetermined value; and a step of storing, as a rotation rate of the vacuum pump for the gas flow mode or for the vacuum mode, which is obtained based on determination of the at least one of steps.

The method as described above according to the present invention is performed to obtain, in advance, a rotation rate of the vacuum pump, which is close to the required minimum rotation rate, which contributes to energy conservation.

The present invention provides a vacuum system with a vacuum pump capable of operating at a rotation rate controlled appropriately when a predetermined process is performed in a vacuum chamber, contributing to energy conservation.

### BRIEF DESCRIPTION OF THE DRAWINGS

The following description and the accompanying drawings clarify characteristics and advantages of the present invention.

FIG. 1 is a block diagram showing a vacuum system according to the first embodiment of the present invention.

FIG. 2 is a flowchart showing a first half of a process of an auto-tuning mode performed in the vacuum system shown in FIG. 1.

FIG. 3 is a flowchart showing a second half of a process of an auto-tuning mode performed in the vacuum system shown in FIG. 1.

FIG. 4(a) is a diagram showing an auto pressure controller (APC) valve of the vacuum system shown in FIG. 1, the APC valve being completely closed.

FIG. 4(b) is a diagram showing the APC valve shown in FIG. 4(a), which is fully open.

FIG. 5(a) is a diagram showing an APC valve different from the APC valve shown in FIGS. 4(a) and 4(b), the APC valve shown in FIG. 5(a) being completely closed.

FIG. 5(b) is a diagram showing the APC valve shown in FIG. 5(a), which is fully open.

FIG. 6 is a flowchart showing a first half of a process of the auto-tuning mode different from the first half of the process of the auto-tuning mode shown in FIG. 2, which is performed in the vacuum system shown in FIG. 1.

FIG. 7 is a flowchart showing a second half of the process of the auto-tuning mode different from the second half of the process of the auto-tuning mode shown in FIG. 3, which is performed in the vacuum system shown in FIG. 1.

FIG. 8 is a flowchart showing a first half of a process of an auto-tuning mode performed in a vacuum system according to the second embodiment of the present invention.

FIG. 9 is a flowchart showing a second half of the process of the auto-tuning mode performed in the vacuum system according to the second embodiment of the present invention.

FIG. 10 is a flowchart showing a first half of a process of the auto-tuning mode different from the first half of the process of the auto-tuning mode shown in FIG. 8, which is performed in the vacuum system according to the second embodiment.

FIG. 11 is a flowchart showing a second half of the process of the auto-tuning mode different from the second half of the process of the auto-tuning mode shown in FIG. 9, which is performed in the vacuum system according to the second embodiment.

FIG. 12 is a block diagram showing a vacuum system according to the third embodiment of the present invention.

FIG. 13 is a block diagram showing a vacuum system according to the fourth embodiment of the present invention.

### DESCRIPTION OF REFERENCE NUMERALS

10: Semiconductor manufacturing system (vacuum system)
21: Process chamber (vacuum chamber)
22: APC valve (gas flow rate control means)
24: Controller for semiconductor manufacturing apparatus
30: Vacuum pump unit
33: Vacuum pump controller
210, 220: Semiconductor manufacturing system (vacuum system)
221: Mass flow controller (MFC) (gas flow rate control means)

### BEST MODE FOR CARRYING OUT THE INVENTION

Embodiments of the present invention will be described with reference to the accompanying drawings.

### FIRST EMBODIMENT

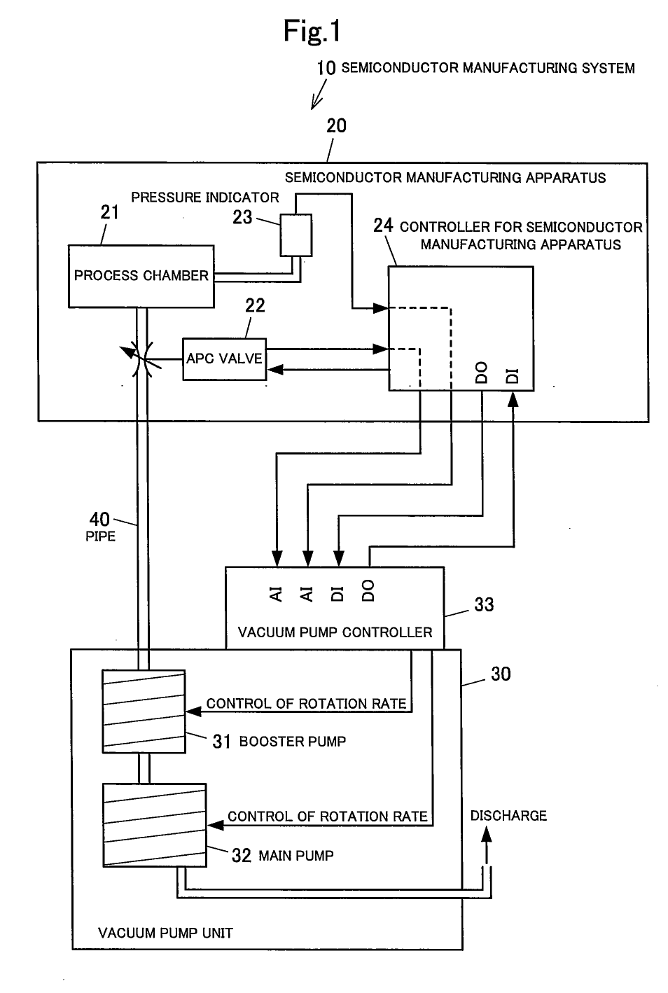

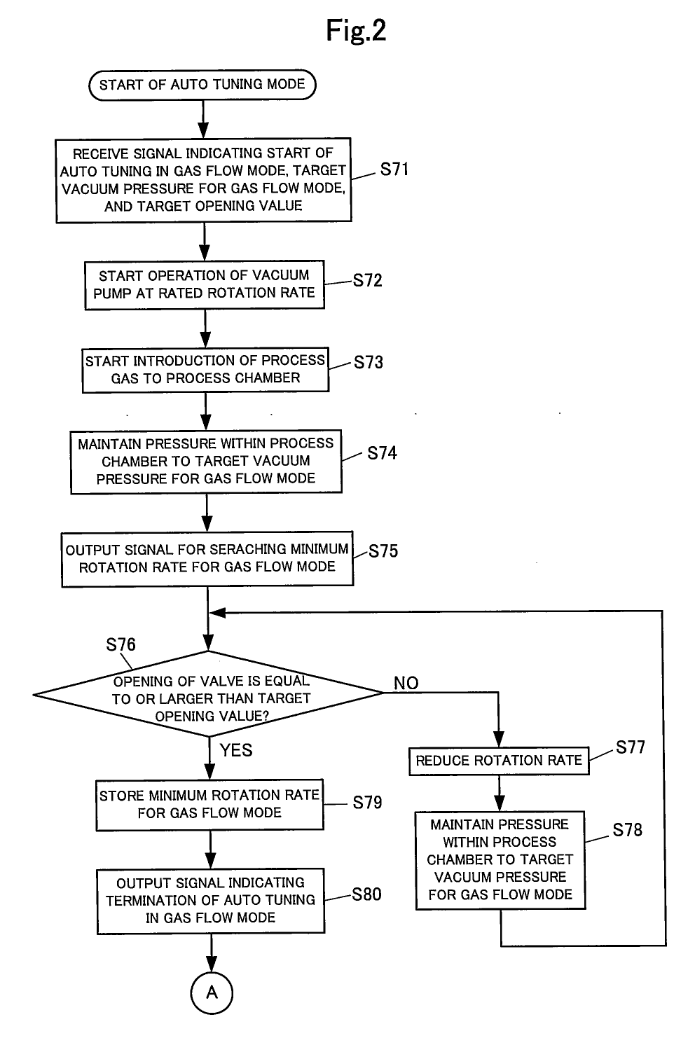

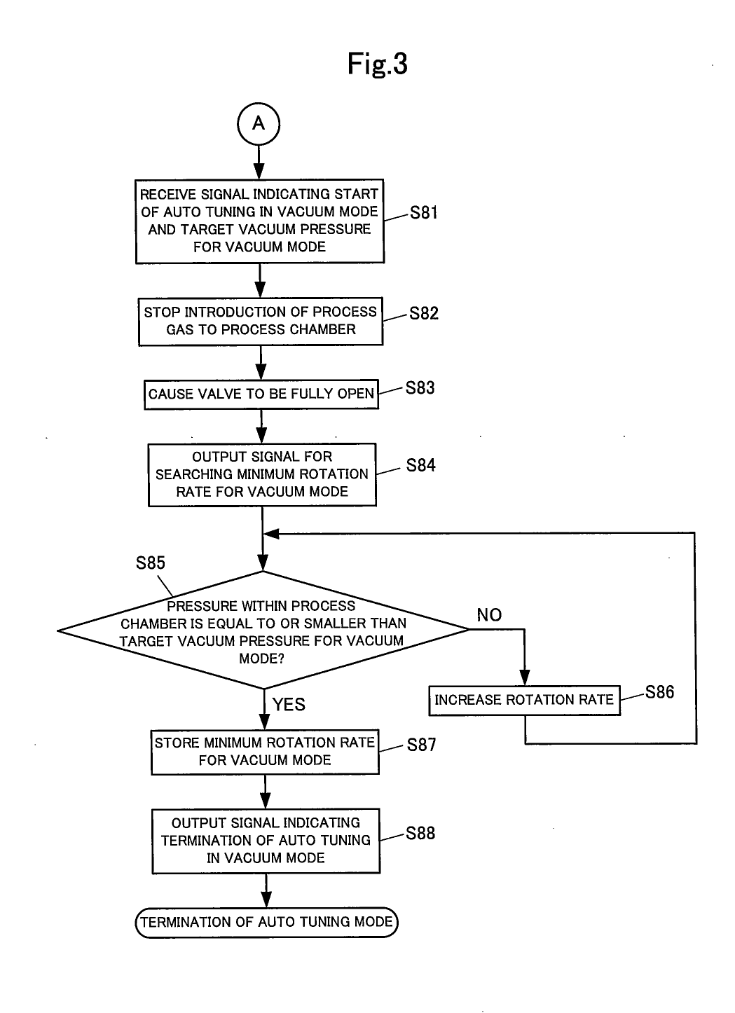

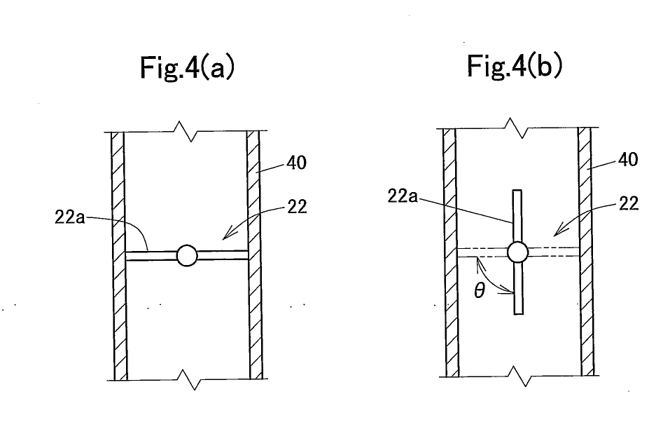

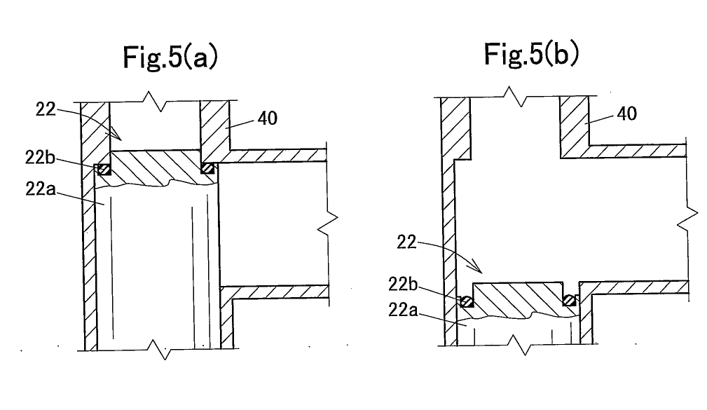

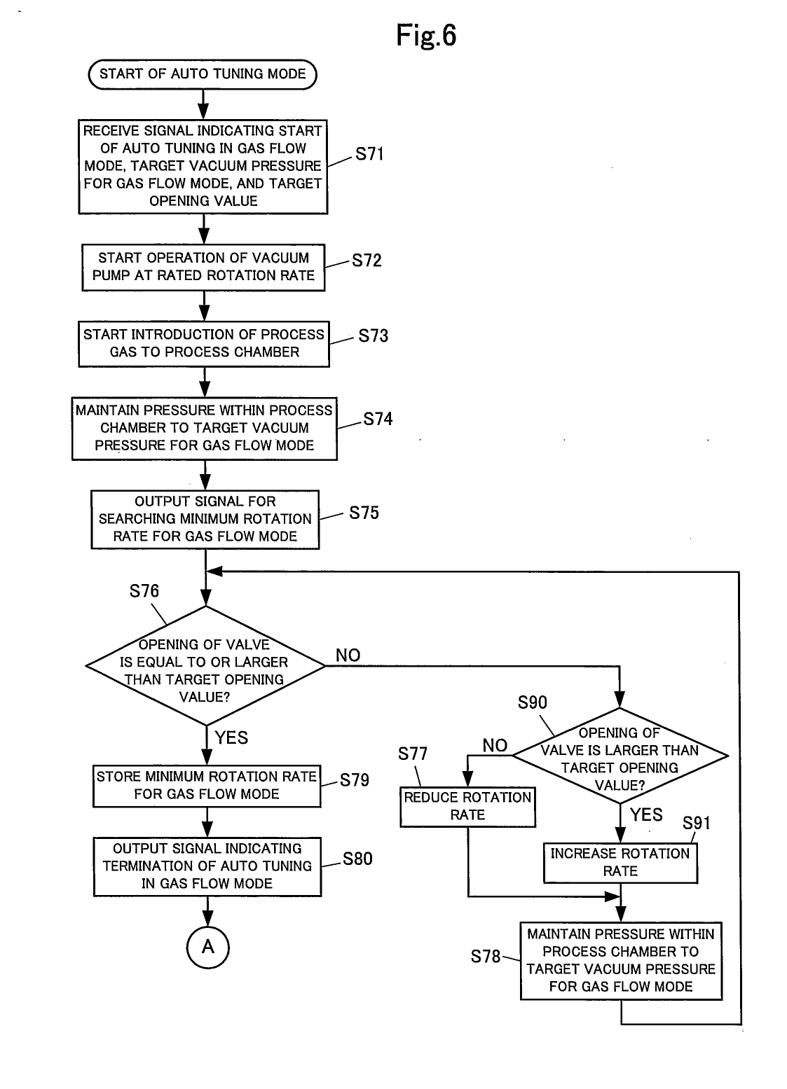

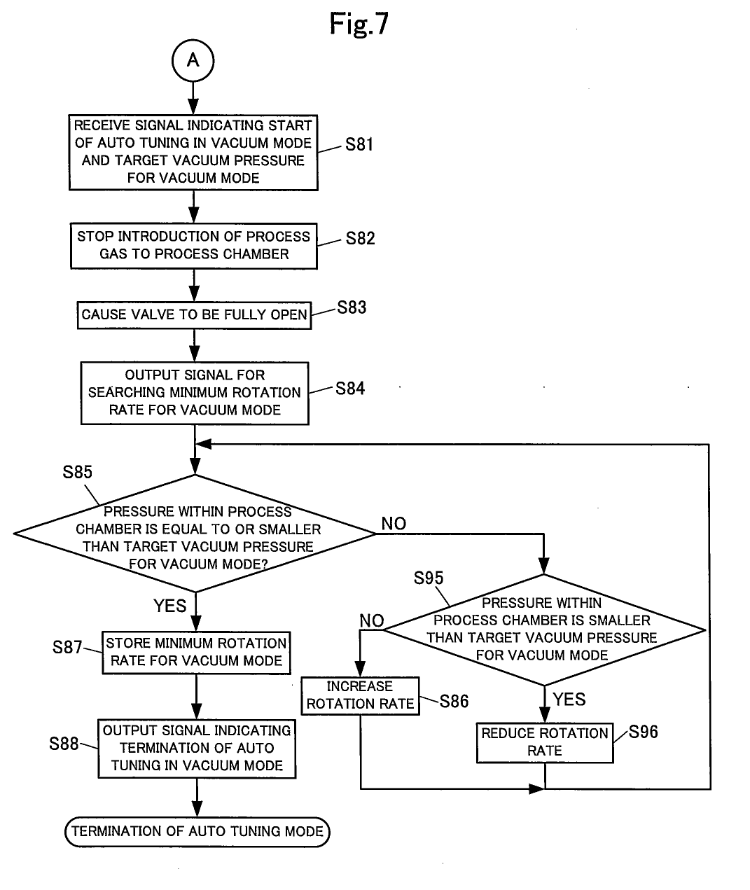

FIG. 1 is a diagram showing a vacuum system according to the first embodiment of the present invention. FIGS. 2 and 3 are flowcharts respectively showing a first and second half of a process of an auto-tuning mode performed in the vacuum system. FIGS. 4(a) and 4(b) are diagrams each showing an auto pressure controller (APC) valve of the vacuum system according to the present invention. FIGS. 5(a) and 5(b) are diagrams each showing an APC valve different from the APC valve shown in FIGS. 4(a) and 4(b). FIGS. 6 and 7 are flowcharts respectively showing a first and second half of a process of an auto-tuning mode performed in the vacuum system, which is different from the auto-tuning mode as shown in FIGS. 2 and 3.

The configuration of the vacuum system will be described below.

As shown in FIG. 1, a semiconductor manufacturing system 10 as the vacuum system according to the present invention comprises a semiconductor manufacturing apparatus 20 having a process chamber 21 used as a vacuum chamber, a vacuum pump unit 30 which is, for example, a two-stage dry vacuum pump for discharging a gas from the process chamber 21, and a pipe 40 for communicating the process chamber 21 with the vacuum pump unit 30.

The semiconductor manufacturing apparatus 20 includes an auto pressure controller (APC) valve 22 as gas flow rate control means for controlling the flow rate of a gas to be discharged from the process chamber 21 to the vacuum pump unit 30, a pressure indicator 23 for measuring pressure within the process chamber 21, and a controller 24 for the semiconductor manufacturing apparatus 20, controller 24 controlling an operation rate (opening) of the APC valve 22 to control the pressure within the process chamber 21.

The vacuum pump unit 30 has a booster pump 31, a main pump 32, and a vacuum pump controller 33 for controlling a rotation rate of the vacuum pump unit 30 (i.e., rotation rates of the booster pump 31 and of the main pump 32) to search a necessary rotation rate of the vacuum pump unit 30.

The vacuum pump controller 33 is designed to receive a signal indicating the opening (closing degree for determining a flow rate of a gas) of the APC valve 22 and a signal indicating a measurement result from the pressure indicator 23.

The controller 24 for the semiconductor manufacturing apparatus 20, and the vacuum pump controller 33 synchronize with each other in accordance with a digital input/output signal, and constitute a controller according to the present invention.

In FIG. 1, “AI” is an abbreviation of an input of an analog signal, “DI” is an abbreviation of an input of a digital signal, and “DO” is an abbreviation of an output of a digital signal.

Next, operations of the semiconductor manufacturing system 10 will be described.

The semiconductor manufacturing system 10 has operation modes including an operation mode for performing a typical process and an auto-tuning mode as a rotation rate search mode for searching the rotation rate of the vacuum pump unit 30, the auto-tuning mode being performed before the operation mode for performing the typical process. The operation mode for performing the typical process includes a gas flow mode for processing a semiconductor product within the process chamber 21 and a vacuum mode for setting pressure within the process chamber 21 to vacuum pressure lower than the pressure within the process chamber 21 in the gas flow mode. In the vacuum mode, the process chamber 21 is communicated with, for example, a load lock chamber (not shown) in order to carry a semiconductor product or to perform vacuum deaeration and the like. Here, the vacuum mode merely indicates a predetermined mode other than the gas flow mode and does not necessarily indicates all modes other than the gas flow mode among the operation modes. In other words, the operation modes may only include the gas flow mode and the vacuum mode, and may include another mode other than the gas flow mode and the vacuum mode.

In the auto-tuning mode shown in FIGS. 2 and 3, the controller 24 for the semiconductor manufacturing apparatus 20 transmits, to the vacuum pump controller 33, a signal indicating the start of the auto tuning in the gas flow mode, a target value of vacuum pressure necessary for the gas flow mode and a target value of the opening of the APC valve 22 in the gas flow mode in step S71.

The target opening value (target value of the closing degree of the gas flow rate control means, which determines the flow rate of a gas) is a target value lower by a predetermined value than the full operation rate (completely closing degree). The target opening value may be one value (e.g., 15%) or may be within a range of, for example, 10 to 20%. In addition, the target opening value may be within a range causing a relatively small ratio of change in the pressure within the process chamber 21 with respect to a change in the operation rate of the APC valve 22, or may be a value appropriate to finely control the opening of the APC valve 22 and control the change of the pressure within the process chamber 21.

In the case where the APC valve 22 is a butterfly valve as shown in FIGS. 4(a) and 4(b), the target opening value appropriate for controlling the pressure within the process chamber 21 is within a range (e.g., 15 to 40%) which causes the following ratio to be small, a ratio of a change in the pressure within the process chamber 21 to a change in inclination angle θ of the valve 22a with respect to the valve 22a shown in FIG. 4(a) is small. The opening (operation rate) of the butterfly valve shown in FIGS. 4(a) and 4(b) is in proportion to the inclination angle θ of the valve 22a with respect to the valve 22a shown in FIG. 4(a). The opening of the valve 22a shown in FIG. 4(a) is 0% (the inclination angle θ is zero degree), while the opening of the valve 22a shown in FIG. 4(b) is 100% (the inclination angle θ is 90 degrees).

In the case where the APC valve 22 is a direct acting valve shown in FIGS. 5(a) and 5(b), the target opening value is preferably 10 to 50%. The opening of the direct acting valve shown in FIG. 5(a) is 0%, while the opening of the direct acting valve shown in FIG. 5(b) is 100%. The direct acting valve shown in FIGS. 5(a) and 5(b) has an O-ring 22b allowing the direct acting valve to be completely closed. Because of the elasticity of the O-ring 22b, controllability of the valve with the opening not larger than 10% is deteriorated. The opening of about 50% results in the valve substantially fully opening. Thus, the opening is preferably within a range from 10 to 50%.

The vacuum pump controller 33 is designed to receive the signal indicating the start of the auto tuning in the gas flow mode from the controller 24 for the semiconductor manufacturing apparatus 20 and to then cause the vacuum pump unit 30 to start to operate at a rated rotation rate sufficiently higher than a rate necessary for discharge in step S72.

The controller 24 for the semiconductor manufacturing apparatus 20 next causes a gas inflow device (not shown) to start introduction of a certain amount of a process gas to the process chamber 21, the certain amount of the process gas being the same as that in the gas flow mode, in step S73. The controller 24 then causes the APC valve 22 to increase the opening thereof when the pressure within the process chamber 21 is higher than the target vacuum pressure necessary for the gas flow mode and to reduce the opening thereof when the pressure within the process chamber 21 is lower than the target vacuum pressure necessary for the gas flow mode so as to maintain the pressure within the process chamber 21 to the target vacuum pressure necessary for the gas flow mode in step S74. The target vacuum pressure necessary for the gas flow mode is a value allowing the semiconductor manufacturing apparatus 20 to stably operate and varies depending on the type of the semiconductor manufacturing apparatus 20 or on a condition of processing a semiconductor product or the like. It is thus necessary that the target vacuum pressure necessary for the gas flow mode be determined by evaluation or measurement on the semiconductor manufacturing apparatus 20 in advance. The target vacuum pressure necessary for the gas flow mode may be 3.5 Torr (=3.5*(101325/760)Pa) and the like in the gas flow mode such as a tetraethoxysilane (TEOS) process for causing a TEOS gas of 100 sccm (standard cubic centimeter per minute, under temperature of 0° C. and at one atmosphere of pressure)), an O₂ gas of 1000 sccm, and an Ar gas of 100 sccm for protecting bellows to flow to the inside of the process chamber 21, and an SiN process for causing a SiH₄ (monosilane) gas of 200 sccm, an NH₃ (ammonia) gas of 900 sccm, an N₂ gas of 600 sccm, and an Ar gas of 100 sccm to flow to the inside of the of the process chamber 21.

The controller 24 then outputs to the vacuum pump controller 33 a signal for causing the vacuum pump controller 33 to search a minimum value of the rotation rate of the vacuum pump unit 30 in step S75, the minimum value being necessary for the gas flow mode.

The vacuum pump controller 33 then determines in step S76 whether or not the opening of the APC valve 22, which is received through the controller 24, is equal to or larger than the target opening value received from the controller 24 in step S71 when the value of the pressure within the process chamber 21, which is received through the controller 24 from the pressure indicator 23, reaches the target vacuum pressure necessary for the gas flow mode, which is received from the controller 24 in step S71.

The vacuum pump controller 33 reduces the rotation rate of the vacuum pump unit 30, i.e., the rotation rate(s) of either one of or both the booster pump 31 and the main pump 32 by a predetermined rate in step S77 when the vacuum pump controller 33 determines that the opening of the APC valve 22 received through the controller 24 is smaller than the target opening value received from the controller 24. When the rotation rate of the vacuum pump unit 30 is reduced, a discharge rate of the vacuum pump unit 30 is also reduced, resulting in a reduction in amount of the process gas flowing through the APC valve 22. The pressure within the process chamber thus becomes higher than the target vacuum pressure necessary for the gas flow mode. The controller 24 changes the opening of the APC valve 22 similarly to step S74 to maintain the pressure within the process chamber 21 to the target vacuum pressure necessary for the gas flow mode in step S78. The vacuum pump controller 33 then performs step S76 again.

The vacuum pump controller 33 stores a current rotation rate of the vacuum pump unit 30, as the minimum rotation rate necessary for the gas flow mode, in step S79 and outputs a signal indicating the termination of the auto tuning in the gas flow mode, when the vacuum pump controller 33 determines that the opening of the APC valve 22 received through the controller 24 becomes equal to or larger than the target opening value received from the controller 24 in step S71.

When the controller 24 receives the signal indicating the termination of the auto tuning in the gas flow mode, the controller 24 transmits, to the vacuum pump controller 33, a signal indicating the start of the auto tuning in the vacuum mode and a signal indicating the target vacuum pressure necessary for the vacuum mode in step S81.

The controller 24 then causes the gas inflow device (not shown) to stop the introduction of the process gas to the process chamber 21 in step S82 and causes the APC valve 22 to increase the opening to 100%, which is the target value for the vacuum mode, in step S83.

The controller 24 then outputs to the vacuum pump controller 33 a signal for causing the vacuum pump controller 33 to search the minimum value of the rotation rate of the vacuum pump unit 30 in step S84, the minimum value being necessary for the vacuum mode.

The vacuum pump controller 33 determines in step S85 whether or not the pressure within the process chamber 21, which is received by the vacuum pump controller 33 from the pressure indicator 23 through the controller 24, is not larger than the target vacuum pressure necessary for the vacuum mode, which is input from the controller 24 in step S81.

When the vacuum pump controller 33 determines that the pressure within the process chamber 21, which is output from the pressure indicator 23 through the controller 24 and input to the vacuum pump controller 33, is larger than the target vacuum pressure necessary for the vacuum mode, which is input from the controller 24, in step S81, the vacuum pump controller 33 increases the rotation rate of the vacuum pump unit 30, i.e., the rotation rate(s) of at least one of the booster pump 31 and the main pump 32 by a predetermined rotation rate in step S86. The process of the auto-tuning mode proceeds back to step S85.

When the vacuum pump controller 33 determines that the pressure value of the process chamber 21, which is output from the pressure indicator 23 through the controller 24 and input to the vacuum pump controller 33, is not larger than the target vacuum pressure necessary for the vacuum mode, which is input from the controller 24, in step S81, the vacuum pump controller 33 stores the current rotation rate of the vacuum pump unit 30 as the minimum rotation rate necessary for the vacuum mode in step S87 and outputs, to the controller 24, a signal indicating the termination of the auto tuning in the vacuum mode in step S88.

The controller 24 terminates the auto-tuning mode shown in FIGS. 2 and 3 when the controller 24 receives the signal indicating the termination of the auto tuning in the vacuum mode from the vacuum pump controller 33.

The vacuum pump controller 33 causes the vacuum pump unit 30 to operate at a higher one of the minimum rotation rate necessary for the gas flow mode, which is stored in step S79, and the minimum rotation rate necessary for the vacuum mode, which is stored in step S87, in the operation mode. The controller 24 causes the gas inflow device (not shown) to stop the introduction of the process gas to the process chamber 21 and causes the APC valve to be fully open in the vacuum mode. The controller 24 causes the gas inflow device (not shown) to continue to introduce to the process chamber 21 the process gas at a flow rate same as that of the process gas introduced to the process chamber 21 in step S73. The controller 24 controls the opening of the APC valve 22 to control the flow rate of the process gas flowing through the APC valve 22. Thus, the controller 24 operates to maintain the pressure within the process chamber 21 to the target vacuum pressure necessary for the gas flow mode. The pressure within the process chamber 21 is lower than the target vacuum pressure necessary for the vacuum mode in the vacuum mode and is equal to the target vacuum pressure necessary for the gas flow mode in the gas flow mode when the minimum rotation rate necessary for the gas flow, which is stored in the vacuum pump controller 33 in step S79, is larger than the minimum rotation rate necessary for the vacuum mode, which is stored in the vacuum pump controller 33 in step S87. When the minimum rotation rate necessary for the gas flow mode, which is stored in the vacuum pump controller 33 in step S79, is not larger than the minimum rotation rate necessary for the vacuum mode, which is stored in the vacuum pump controller 33 in step S87, the pressure within the process chamber 21 is equal to the target vacuum pressure necessary for the vacuum mode in the vacuum mode, and is equal to the target vacuum pressure necessary for the gas flow mode in the gas flow mode although there is a possibility that the opening of the APC valve 22 does not reach the target opening value in the gas flow mode.

As described above, the vacuum pump controller 33 changes the rotation rate of the vacuum pump unit 30 under the condition that the controller 24 controls the opening of the APC valve 22 to maintain the pressure within the process chamber 21 to the target vacuum pressure necessary for the gas flow mode, so as to search the minimum rotation rate necessary for the gas flow mode, i.e., the rotation rate of the vacuum pump unit 30 which is required to set the pressure within the process chamber 21 to the target vacuum pressure necessary for the gas flow mode, in the auto-tuning mode prior to the operation mode. The vacuum pump controller 33 changes the rotation rate of the vacuum pump unit 30 under the condition that the controller 24 controls the opening of the APC valve 22 to be the opening of 100%, or the target vacuum pressure necessary for the vacuum mode, so as to search the minimum rotation rate necessary for the vacuum mode, i.e., the rotation rate of the vacuum pump unit 30 which is required to set the pressure within the process chamber 21 to the target vacuum pressure necessary for the vacuum mode, in the auto-tuning mode prior to the operation mode. The vacuum pump controller 33 causes the vacuum pump unit 30 to operate at a higher one of the minimum rotation rate necessary for the gas flow mode and the minimum rotation rate necessary for the vacuum mode. Specifically, the semiconductor manufacturing system 10 causes the vacuum pump unit 30 to operate in the operation mode at a certain rotation rate searched before the operation mode. The semiconductor manufacturing system 10 allows the vacuum pump unit 30 to operate at a more rotation rate appropriate than the conventional techniques, contributing to energy conservation.

The vacuum pump controller 33 is designed to continuously search the minimum rotation rate necessary for the gas flow mode and the minimum rotation rate necessary for the vacuum mode in the auto-tuning mode, and to cause the vacuum pump unit 30 to operate at a higher one of the minimum rotation rate necessary for the gas flow mode and the minimum rotation rate necessary for the vacuum mode. The semiconductor manufacturing system 10, therefore, is capable of stably controlling the pressure within the process chamber 21 since it is not necessary that the rotation rate of the vacuum pump unit 30 be changed when a change between the gas flow mode and the vacuum mode is made.

The vacuum pump controller 33 may be designed to search the minimum rotation rate necessary for the vacuum mode and the minimum rotation rate necessary for the gas flow mode in the auto-tuning mode which is not performed in synchronization with the vacuum mode and the gas flow mode, and to cause the vacuum pump unit 30 to operate at the minimum rotation rate necessary for the vacuum mode in the vacuum mode and at the minimum rotation rate necessary for the gas flow mode in the gas flow mode, when there is sufficient time to stabilize the pressure within the process chamber 21 during a change between the vacuum mode and the gas flow mode. The semiconductor manufacturing system 10 is capable of controlling the pressure within the process chamber 21 with lower energy consumption when the vacuum pump controller 33 causes the vacuum pump unit 30 to operate at the minimum rotation rate necessary for the vacuum mode in the vacuum mode and at the minimum rotation rate necessary for the gas flow mode in the gas flow mode.

The auto-tuning mode of the present invention, in which the minimum rotation rate for each of the modes is searched, may be applied to the case where the operation mode includes either one of the gas flow mode and the vacuum mode, and to the case where the operation mode includes multiple different gas flow mode and vacuum mode.

The vacuum pump controller 33 is designed to separately store the minimum rotation rate necessary for the gas flow mode and the minimum rotation rate necessary for the vacuum mode. The vacuum pump controller 33, however, is capable of causing the vacuum pump unit 30 to operate at a higher one of the minimum rotation rate necessary for the gas flow mode and the minimum rotation rate necessary for the vacuum mode in the operation mode even if the vacuum pump controller 33 is designed to overwrite, in step S87, the rotation rate of the vacuum pump unit 30 stored in step S79 when the minimum rotation rate necessary for the vacuum mode is larger than the minimum rotation rate necessary for the gas flow mode.

The controller 24 is designed to transmit a signal indicating the target vacuum pressure necessary for the vacuum mode to the vacuum pump controller 33 in step S81. The controller 24 may be designed to transmit the signal indicating the target vacuum pressure necessary for the vacuum mode and the target opening value to the vacuum pump controller 33 in step S71.

The controller 24 is designed to maintain the pressure within the process chamber 21 to the target vacuum pressure necessary for the gas flow mode in step S78 by using, as a trigger, the change of the pressure within the process chamber 21 from the target vacuum pressure necessary for the gas flow mode. The controller 24, however, may be designed to maintain the pressure within the process chamber 21 to the target vacuum pressure necessary for the gas flow mode in step S78 by using, as a trigger, a notification indicative of the rotation rate reduced by the vacuum pump controller 33 in step S77.

The vacuum pump controller 33 is designed to determine that the pressure within the process chamber 21 is equal to the target vacuum pressure necessary for the gas flow mode in accordance with the value of the pressure within the process chamber 21, which is received by the vacuum pump controller 33 from the pressure indicator 23 through the controller 24. The vacuum pump controller 33, however, may be designed to determine that the pressure within the process chamber 21 is equal to the target vacuum pressure necessary for the gas flow mode in accordance with a change in the opening of the APC valve 22, which is received by the vacuum pump controller 33 through the controller 24. The vacuum pump controller 33 may also be designed to determine that the pressure within the process chamber 21 is equal to the target vacuum pressure necessary for the gas flow mode when the APC valve 22 stops or when the APC valve 22 is reversely moved. When the vacuum pump controller 33 is designed to determine that the pressure within the process chamber 21 is equal to the target vacuum pressure necessary for the gas flow mode in accordance with the change in opening of the APC valve 22, which is received by the vacuum pump controller 33 through the controller 24, the vacuum pump controller 33 does not need to receive the target vacuum pressure necessary for the gas flow mode through the controller 24.

The vacuum pump controller 33 is designed to reduce the rotation rate of the vacuum pump unit 30 from a rated rotation rate and search the minimum rotation rate necessary for the gas flow mode. The vacuum pump controller 33, however, may be designed to increase the rotation rate of the vacuum pump unit 30 from a minimum rotation rate allowing vacuum pressure necessary for the gas flow mode to be maintained and search the minimum rotation rate necessary for the gas flow mode.

The vacuum pump controller 33 is designed to perform step S76. The controller 24 may be designed to perform step S76. In addition, the controller 24 may be designed to perform step S85. If the controller 24 is designed to perform step S76, the vacuum pump controller 33 does not need to receive the opening of the APC valve 22 through the controller 24. If the controller 24 is designed to perform steps S76 and S85, the vacuum pump controller 33 does not need to receive a result of measurement performed by the pressure indicator 23 through the controller 24.

The vacuum pump controller 33 is designed to determine whether or not the opening of the APC valve 22 is not smaller than the target opening value. When the vacuum pump controller 33 determines that the opening of the APC valve 22 is smaller than the target opening value in step S76, the vacuum pump controller 33 reduces the rotation rate of the vacuum pump unit 30 by a predetermined rate in step S77. When the vacuum pump controller 33 determines in step S76 that the opening of the APC valve 22 is not smaller than the target opening value, the vacuum pump controller 33 stores the current rotation rate of the vacuum pump unit 30 as the minimum rotation rate necessary for the gas flow mode in step S79. Like the process of the auto-tuning mode shown in FIGS. 6 and 7, the vacuum pump controller 33 may be designed to operate as follows. That is, when the vacuum pump controller 33 determines that the opening of the APC valve 22 is not equal to the target opening value in step S76, the vacuum pump controller 33 next determines whether or not the opening of the APC valve 22 is larger than the target opening value in step S90. When the opening of the APC valve 22 is not larger than the target opening value, or when the vacuum pump controller 33 determines that the opening of the APC valve 22 is smaller than the target opening value in step S90, the vacuum pump controller 33 decreases the rotation rate of the vacuum pump unit 30 by a predetermined rate in step S77. When the vacuum pump controller 33 determines that the opening of the APC valve 22 is larger than the target opening value in step S90, the vacuum pump controller 33 increases the rotation rate of the vacuum pump unit 30 by a predetermined rate in step S91. In this case, when the vacuum pump controller 33 determines that the opening of the APC valve 22 is equal to the target opening value in step S76, the vacuum pump controller 33 stores the current rotation rate of the vacuum pump unit 30 as the minimum rotation rate necessary for the gas flow mode.

When the process shown in FIG. 6 proceeds from step S77, in which the rotation rate of the vacuum pump unit 30 is reduced, to step S91, in which the rotation rate is increased, the difference between the rotation rate before the increase is carried out in step S91 and the rotation rate after the increase is carried out in step S91 is smaller than the difference between the rotation rate before the reduction is carried out in step S77 and the rotation rate after the reduction is carried out in step S77. When the process shown in FIG. 6 proceeds from step S91, in which the rotation rate of the vacuum pump unit 30 is increased, to step S77, in which the rotation rate is reduced, the difference between the rotation rate before the reduction is carried out in step S77 and the rotation rate after the reduction is carried out in step S77 is smaller than the difference between the rotation rate before the increase is carried out in step S91 and the rotation rate after the increase is carried out in step S91. Thus, the opening of the APC valve 22 can converge to the target opening value.

The vacuum pump controller 33 may be designed as follows. That is, the vacuum pump controller 33 determines whether or not the pressure within the process chamber 21 is not larger than the target vacuum pressure necessary for the vacuum mode in step S85. When the vacuum pump controller 33 determines that the pressure within the process chamber 21 is larger than the target vacuum pressure necessary for the vacuum mode in step S85, the vacuum pump controller 33 increases the rotation rate of the vacuum pump unit 30 by a predetermined rate. When the vacuum pump controller 33 determines that the pressure within the process chamber 21 is not larger than the target vacuum pressure necessary for the vacuum mode in step S85, the vacuum pump controller 33 determines whether or not the pressure within the process chamber 21 is equal to the target vacuum pressure necessary for the vacuum mode in step S85 as shown in FIG. 7, without storing the rotation rate of the vacuum pump unit 30 as the minimum rotation rate necessary for the vacuum mode in step S87. When the vacuum pump controller 33 determines that the pressure within the process chamber 21 is not equal to the target vacuum pressure necessary for the vacuum mode in step S85, the vacuum pump controller 33 determines whether or not the pressure within the process chamber 21 is smaller than the target vacuum pressure necessary for the vacuum mode in step S95. When the vacuum pump controller 33 determines that the pressure within the process chamber 21 is larger than the target vacuum pressure necessary for the vacuum mode in step S95, the vacuum pump controller 33 increases the rotation rate of the vacuum pump unit 30 by a predetermined rate in step S86. When the vacuum pump controller 33 determines that the pressure within the process chamber 21 is smaller than the target vacuum pressure necessary for the vacuum mode in step S95, the vacuum pump controller 33 reduces the rotation rate of the vacuum pump unit 30 by a predetermined rate in step S96. When the vacuum pump controller 33 determines that the pressure within the process chamber 21 is equal to the target vacuum pressure necessary for the vacuum mode in step S85, the vacuum pump controller 33 stores the rotation rate of the vacuum pump unit 30 as the minimum rotation rate necessary for the vacuum mode in step S87.

When the process shown in FIG. 7 proceeds from step S86, in which the rotation rate of the vacuum pump unit 30 is increased, to step S96, in which the rotation rate is reduced, the difference between the rotation rate before the reduction is carried out in step S96 and the rotation rate after the reduction is carried out in step S96 is smaller than the difference between the rotation rate before the increase is carried out in step S86 and the rotation rate after the increase is carried out in step S86. When the process shown in FIG. 7 proceeds from step S96, in which the rotation rate of the vacuum pump unit 30 is reduced, to step S86, in which the rotation rate is increased, the difference between the rotation rate before the increase is carried out in step S86 and the rotation rate after the increase is carried out in step S86 is smaller than the difference between the rotation rate before the reduction is carried out in step S96 and the rotation rate after the reduction is carried out in step S96. Thus, the pressure within the process chamber 21 can converge to the target vacuum pressure necessary for the vacuum mode.

In the present embodiment, the controller 24 and the vacuum pump controller 33 constitute the controller according to the present invention. The controller according to the present invention, however, may not be a single controller.

The semiconductor manufacturing system 10 can control the pressure within the process chamber 21 in the operation mode under the condition that the APC valve 22 is sufficiently open. The semiconductor manufacturing system 10, therefore, is capable of preventing the following problem occurring in the state of the semiconductor manufacturing system 10 controlling the pressure within the process chamber 21 under the condition that the vacuum pump unit 30 operates at a higher rotation rate than that in the present embodiment and the APC valve 22 is substantially closed. That is, in the above-described state, since the vacuum pump unit 30 operates at a higher rotation rate than that in the present embodiment, the ratio of the amount of the reduction in the pressure within the process chamber 21 to the amount of the increase in the opening of the APC valve 22 is larger than that in the present embodiment, which causes difficulty in finely controlling the pressure within the process chamber 21. In the above-described state, when a process gas, which is easily solidified, is used, and the process gas is solidified and accumulated in a path within the APC valve 22, the path within the APC valve 22 is narrowed. This may causes difficulty in control of the pressure within the process chamber 21. In the above-described state, when a process gas, which is easily solidified, is used and solidified and stuck to the path, the APC valve 22 may not operate.

### SECOND EMBODIMENT

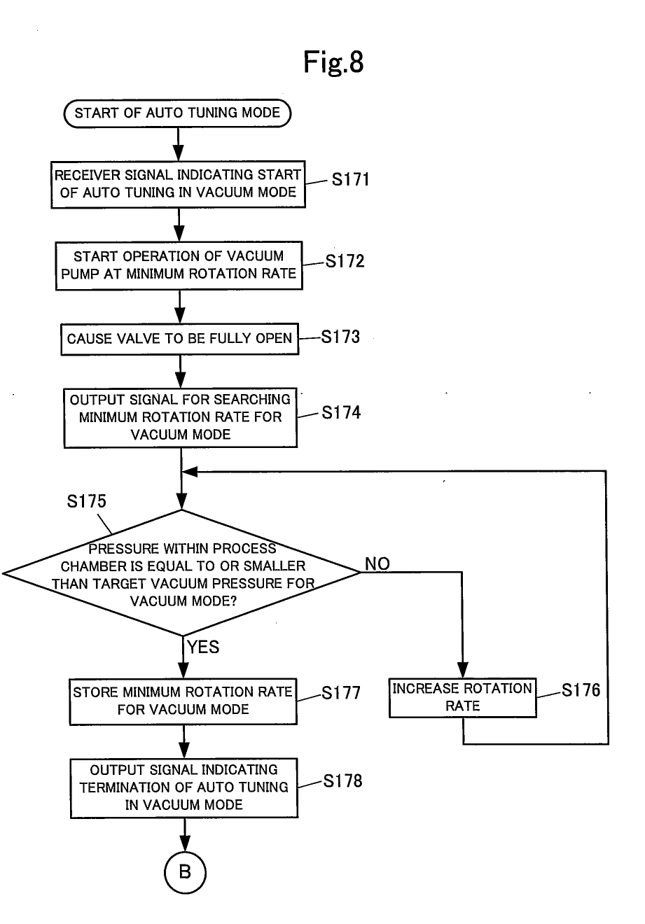

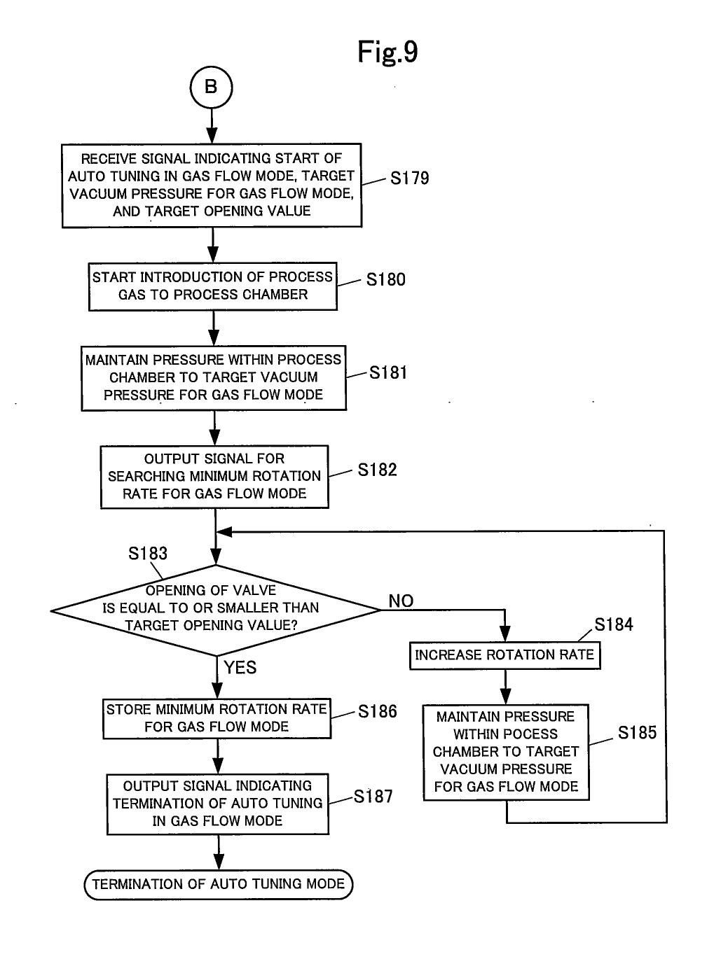

Each of FIGS. 8 and 9 is a flowchart showing a process of the auto-tuning mode of the vacuum system according to the second embodiment of the present invention. The configuration of the semiconductor manufacturing system used as the vacuum system according to the second embodiment of the present invention is similar to the configuration of the semiconductor manufacturing system 10 according to the first embodiment as shown in FIG. 1. The same elements of the semiconductor manufacturing system according to the second embodiment as those of the semiconductor manufacturing system 10 are denoted by the same reference numerals to thereby omit a description thereof.

Operations of the semiconductor manufacturing system according to the second embodiment will be described below.

In the auto-tuning mode as shown in FIGS. 8 and 9, the controller 24 transmits the signal indicating the start of the auto tuning in the vacuum mode and the target vacuum pressure necessary for the vacuum mode to the vacuum pump controller 33 in step S171.

When the vacuum pump controller 33 receives the signal indicating the start of the auto tuning in the vacuum mode from the controller 24, the vacuum pump controller 33 causes the vacuum pump unit 30 to start to operate at a minimum rotation rate necessary for the operation of the vacuum pump unit 30 in step S172.

The controller 24 next causes the APC valve 22 to be fully open, or to increase the opening to 100%, which is the target value for the vacuum mode in step S173 under the condition that the controller 24 causes the gas inflow device (not shown) to stop the introduction of the process gas to the process chamber 21.

The controller 24 then outputs to the vacuum pump controller 33 the signal for causing the vacuum pump controller 33 to search the rotation rate of the vacuum pump unit 30 in the vacuum mode in step S174.

When the vacuum pump controller 33 receives the signal for causing the vacuum pump controller 33 to search the rotation rate in the vacuum mode from the controller 24, the vacuum pump controller 33 determines in step S175 whether or not the pressure within the process chamber 21, which is received from the pressure indicator through the controller 24, is not larger than the target vacuum pressure necessary for the vacuum mode, which is received from the controller 24, in step S171.

When the vacuum pump controller 33 determines in step S175 that the pressure within the process chamber 21, which is received from the pressure indicator through the controller 24, is larger than the target vacuum pressure necessary for the vacuum mode, which is received from the controller 24, in step S171, the vacuum pump controller 33 increases the rotation rate of the vacuum pump unit 30, or a rotation rate(s) of at least one of the booster pump 31 and the main pump 32 by a predetermined rate in step S176. The process then proceeds to step S175.

On the other hand, when the vacuum pump controller 33 determines in step S175 that the pressure within the process chamber 21, which is received from the pressure indicator through the controller 24, is not larger than the target vacuum pressure necessary for the vacuum mode, which is received from the controller 24, in step S171, the vacuum pump controller 33 stores the current rotation rate of the vacuum pump unit 30 as the minimum rotation rate necessary for the vacuum mode in step S177 and outputs the signal indicating the termination of the auto tuning in the vacuum mode to the controller 24 in step S178.

When the controller 24 receives the signal indicating the termination of the auto tuning in the vacuum mode from the vacuum pump controller 33, the controller 24 outputs, to the vacuum pump controller 33, the signal indicating the start of the auto tuning in the gas flow mode, the target vacuum pressure necessary for the gas flow mode, the target opening value which is a target value of the opening of the APC valve 22 for the gas flow mode in step S179.

The controller 24 then causes the gas inflow device (not shown) to start introduction of a certain amount of a process gas to the process chamber 21 in step S180, the amount of the process gas being the same as that in the gas flow mode. The controller 24 causes the APC valve 22 to be fully open when the pressure within the process chamber 21 is higher than the target vacuum pressure necessary for the gas flow mode, and causes the APC valve 22 to reduce the opening thereof when the pressure within the process chamber 21 is lower than the target vacuum pressure necessary for the gas flow mode, so as to maintain the pressure within the process chamber 21 to the target vacuum pressure necessary for the gas flow mode in step S181. The controller 24 then outputs to the vacuum pump controller 33 the signal for causing the vacuum pump controller 33 to search the rotation rate in the gas flow mode in step S182.

The vacuum pump controller 33 determines in step S183 whether or not the opening of the APC valve 22, which is received through the controller 24, is not larger than the target opening value received from the controller 24 in step S179 when the pressure within the process chamber 21, which is received from the pressure indicator 23 through the controller 24, is equal to the target vacuum pressure necessary for the gas flow mode, which is received from the controller 24, in step S179.

When the vacuum pump controller 33 determines in step S183 that the opening of the APC valve 22, which is received through the controller 24, is not larger than the target opening value received from the controller 24 in step S179, the vacuum pump controller 33 increases the rotation rate of the vacuum pump unit 30, or a rotation rate(s) of at least one of the booster pump 31 and the main pump 32 by a predetermined rate in step S184. In the case where the rotation rate of the vacuum pump unit 30 increases, a discharge rate of the vacuum pump unit 30 increases and the amount of the process gas flowing through the APC valve 22 also increases. The pressure within the process chamber 21 thus becomes lower than the target vacuum pressure necessary for the gas flow mode. The controller 24 then causes the APC valve 22 to change the opening in order to maintain the pressure within the process chamber 21 to the target vacuum pressure necessary for the gas flow mode in step S185. The vacuum pump controller 33 performs step S183.

When the vacuum pump controller 33 determines in step S183 that the opening of the APC valve 22, which is received through the controller 24, is not larger than the target opening value received from the controller 24 in step S179, the vacuum pump controller 33 stores the current rotation rate of the vacuum pump unit 30 as the minimum rotation rate necessary for the gas flow mode in step S186 and outputs the signal indicating the termination of the auto tuning in the gas flow mode to the controller 24 in step S187.

When the controller 24 receives the signal indicating the termination of the auto tuning in the gas flow mode from the vacuum pump controller 33, the auto-tuning mode shown in FIGS. 8 and 9 is terminated.

The vacuum pump controller 33 then causes the vacuum pump unit 30 to operate at a higher one of the minimum rotation rate necessary for the vacuum mode stored in step S177 and the minimum rotation rate necessary for the gas flow mode stored in step S186 in the operation mode. The controller 24 causes the gas inflow device (not shown) to stop the introduction of the process gas to the process chamber 21 and causes the APC valve 22 to be fully open in the vacuum mode. In the gas flow mode, the controller 24 causes the gas inflow device (not shown) to continue the introduction of the process gas to the process chamber 21, the amount of the process gas being the same as that of the process gas introduced to the process chamber 21 in step S180, and controls the opening of the APC valve 22 to adjust the amount of the process gas flowing through the APC valve 22. The pressure within the process chamber 21 is thus maintained to the target vacuum pressure necessary for the gas flow mode. When the minimum rotation rate necessary for the gas flow mode stored by the vacuum pump controller 33 in step S186 is larger than the minimum rotation rate necessary for the vacuum mode stored by the vacuum pump controller 33 in step S177, the pressure within the process chamber 21 is lower than the target vacuum pressure necessary for the vacuum mode in the vacuum mode and is equal to the target vacuum pressure necessary for the gas flow mode in the gas flow mode. When the minimum rotation rate necessary for the gas flow mode, which is stored by the vacuum pump controller 33 in step S186, is not larger than the minimum rotation rate necessary for the vacuum mode, which is stored by the vacuum pump controller 33 in step S177, the pressure within the process chamber 21 is equal to the target vacuum pressure necessary for the vacuum mode in the vacuum mode, and is equal to the target vacuum pressure necessary for the gas flow mode in the gas flow mode although there is a possibility that the opening of the APC valve 22 does not reach the target opening value.

The semiconductor manufacturing system according to the present embodiment is designed to operate as described above and can obtain an effect similar to the semiconductor manufacturing system 10 (see FIG. 1) according to the first embodiment.

The vacuum pump controller 33 may be designed to search the minimum rotation rate necessary for the vacuum mode and the minimum rotation rate necessary for the gas flow mode in the auto-tuning mode which is not performed in synchronization with the vacuum mode and the gas flow mode, and to cause the vacuum pump unit 30 to operate at the minimum rotation rate necessary for the vacuum mode in the vacuum mode and at the minimum rotation rate necessary for the gas flow mode in the gas flow mode, when there is sufficient time to stabilize the pressure within the process chamber 21 during a change between the vacuum mode and the gas flow mode. The semiconductor manufacturing system 10 is capable of controlling the pressure within the process chamber 21 with lower energy consumption when the vacuum pump controller 33 causes the vacuum pump unit 30 to operate at the minimum rotation rate necessary for the vacuum mode in the vacuum mode and at the minimum rotation rate necessary for the gas flow mode in the gas flow mode.

The vacuum pump controller 33 is designed to separately store the minimum rotation rate necessary for the gas flow mode and the minimum rotation rate necessary for the vacuum mode. The vacuum pump controller 33, however, is capable of causing the vacuum pump unit 30 to operate at a higher one of the minimum rotation rate necessary for the gas flow mode and the minimum rotation rate necessary for the vacuum mode in the operation mode even if the vacuum pump controller 33 is designed to overwrite, in step S186, the rotation rate of the vacuum pump unit 30 stored in step S177 when the minimum rotation rate necessary for the gas flow mode is larger than the minimum rotation rate necessary for the vacuum mode.

The controller 24 is designed to output the target vacuum pressure necessary for the gas flow mode and the target opening value to the vacuum pump controller 33 in step S179. The controller 24, however, may be designed to output the above-described two values and the target vacuum pressure necessary for the vacuum mode to the vacuum pump controller 33 in step S171.

The vacuum pump controller 33 is designed to increase the rotation rate of the vacuum pump unit 30 from the minimum operational rotation rate of the vacuum pump unit 30 and to thereby search the minimum rotation rate necessary for the vacuum mode. The vacuum pump controller 33, however, may be designed to reduce the rotation rate of the vacuum pump unit 30 from a rated rotation rate and to thereby search the minimum rotation rate necessary for the vacuum mode.

The vacuum pump controller 33 is designed to determine in step S183 whether or not the pressure within the process chamber 21 is equal to the target vacuum pressure necessary for the gas flow mode in accordance with the value of the pressure within the process chamber 21, which is received from the pressure indicator 23 through the controller 24. The vacuum pump controller 33, however, may be designed to determine whether or not the pressure within the process chamber 21 is equal to the target vacuum pressure necessary for the gas flow mode in accordance with a change in the opening of the APC valve 22, which is received through the controller 24. The vacuum pump controller 33 may be also designed to determine whether or not the pressure within the process chamber 21 is maintained to the target vacuum pressure necessary for the gas flow mode when the operation of the APC valve stops or when the APC valve is reversely moved. If the vacuum pump controller 33 is designed to determine whether or not the pressure within the process chamber 21 is equal to the target vacuum pressure necessary for the gas flow mode in accordance with a change in the opening of the APC valve 22, which is received through the controller 24, the vacuum pump controller 33 does not need to receive the value of the pressure within the process chamber 21 from the controller 24.

The controller 24 is designed to maintain the pressure within the process chamber 21 to the target vacuum pressure necessary for the gas flow mode in step S185 by using, as a trigger, the change of the pressure within the process chamber 21 from the target vacuum pressure necessary for the gas flow mode. The controller 24, however, may be designed to maintain the pressure within the process chamber 21 to the target vacuum pressure necessary for the gas flow mode in step S185 by using, as a trigger, a notification indicative of the rotation rate reduced by the vacuum pump controller 33 in step S184.

The vacuum pump controller 33 is designed to perform step S175. The controller 24, however, may be designed to perform step S175. The controller 24 may be also designed to perform step S183. If the controller 24 is designed to perform step S183, the vacuum pump controller 33 does not need to receive the opening of the APC valve 22 through the controller 24. If the controller 24 is designed to perform steps S175 and S183, the vacuum pump controller 33 does not need to receive the a result of measurement performed by the pressure indicator 23 through the controller 24.

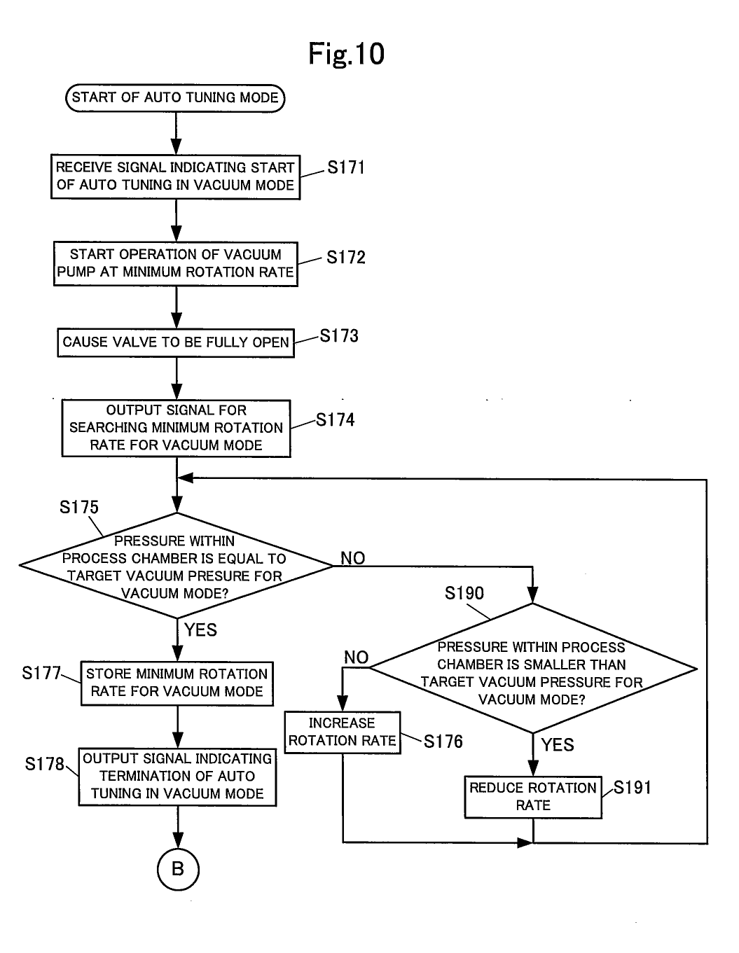

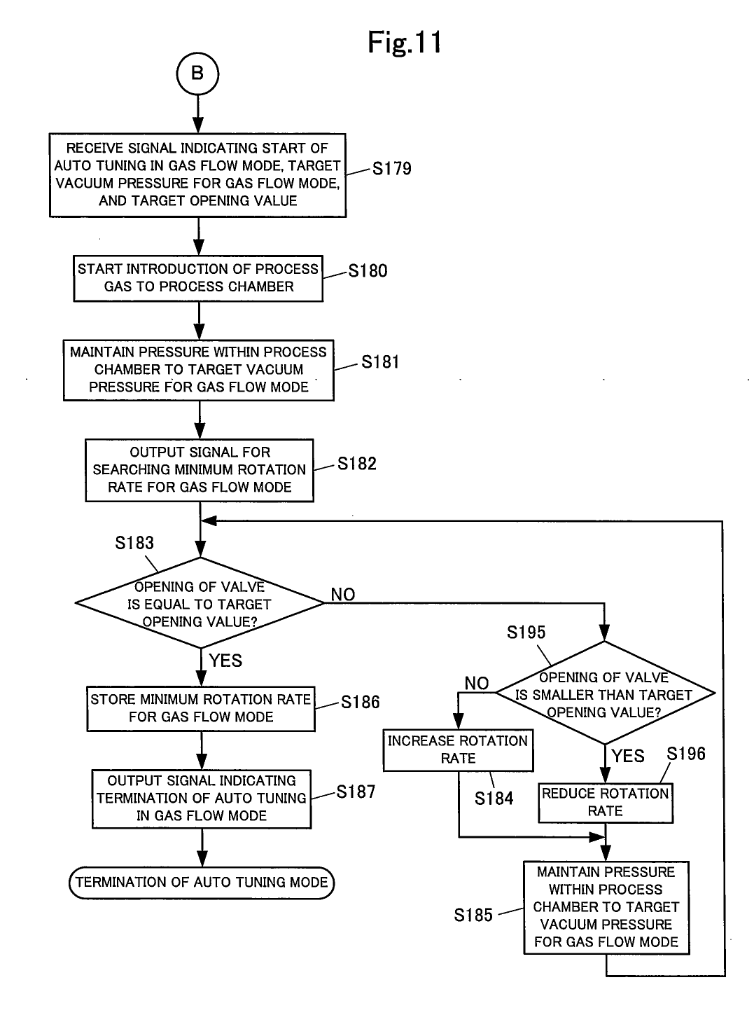

The vacuum pump controller 33 is designed to increase the rotation rate of the vacuum pump unit 30 by a predetermined rate when the vacuum pump controller 33 determines in step S175 that the pressure within the process chamber 21 is larger than the target vacuum pressure necessary for the vacuum mode. The vacuum pump controller 33 is also designed to store the rotation rate of the vacuum pump unit 30 as the minimum rotation rate necessary for the vacuum mode in step S177 when the vacuum pump controller 33 determines in step S175 that the pressure within the process chamber 21 is not larger than the target vacuum pressure necessary for the vacuum mode. The vacuum pump controller 33, however, may be designed to operate as shown in FIGS. 10 and 11. That is, the vacuum pump controller 33 determines in step S175 whether or not the pressure within the process chamber 21 is equal to the target vacuum pressure necessary for the vacuum mode. When the vacuum pump controller 33 determines in step S175 that the pressure within the process chamber 21 is not equal to the target vacuum pressure necessary for the vacuum mode, the vacuum pump controller 33 determines whether or not the pressure within the process chamber 21 is smaller than the target vacuum pressure necessary for the vacuum mode in step S190. When the pressure within the process chamber 21 is not smaller than the target vacuum pressure necessary for the vacuum mode, or when the vacuum pump controller 33 determines that the pressure within the process chamber 21 is larger than the target vacuum pressure necessary for the vacuum mode in step S190 (No in step S190), the vacuum pump controller 33 increases the rotation rate of the vacuum pump unit 30 by a predetermined rate in step S176. When the vacuum pump controller 33 determines that the pressure within the process chamber 21 is smaller than the target vacuum pressure necessary for the vacuum mode in step S190 (Yes in step S190), the vacuum pump controller 33 reduces the rotation rate of the vacuum pump unit 30 by a predetermined rate in step S191. In this case, when the pressure within the process chamber 21 is equal to the target vacuum pressure necessary for the vacuum mode (Yes in step S175), the vacuum pump controller 33 stores the rotation rate of the vacuum pump unit 30 as the minimum rotation rate necessary for the vacuum mode in step S177.

When a process shown in FIG. 10 proceeds from step S176 in which the rotation rate of the vacuum pump unit 30 is increased, to step S191, in which the rotation rate is reduced, the difference between the rotation rate before the reduction is carried out in step S191 and the rotation rate after the reduction is carried out in step S191 is smaller than the difference between the rotation rate before the increase is carried out in step S176 and the rotation rate after the increase is carried out in step S176. On the other hand, when the process shown in FIG. 10 proceeds from step S191, in which the rotation rate of the vacuum pump unit 30 is reduced, to step S176 in which the rotation rate is increased, the difference between the rotation rate before the increase is carried out in step S176 and the rotation rate after the increase is carried out in step S176 is smaller than the difference between the rotation rate before the reduction is carried out in step S191 and the rotation rate after the reduction is carried out in step S191. Thus, the pressure within the process chamber 21 can converge to the target vacuum pressure necessary for the vacuum mode.

The vacuum pump controller 33 determines whether or not the opening of the APC valve 22 is not larger than the target opening value in step S183. When the vacuum pump controller 33 determines that the opening of the APC valve 22 is larger than the target opening value in step S183, the vacuum pump controller 33 increases the rotation rate of the vacuum pump unit 30 by a predetermined rate in step S184. When the vacuum pump controller 33 determines that the opening of the APC valve 22 is not larger than the target opening value in step S183, the vacuum pump controller 33 stores the current rotation rate of the vacuum pump unit 30 as the minimum rotation rate necessary for the gas flow mode in step S186. The vacuum pump controller 33, however, may be designed to operate as follows. That is, as shown in FIG. 11, the vacuum pump controller 33 determines in step S183 whether or not the opening of the APC valve 22 is equal to the target opening value. When the vacuum pump controller 33 determines in step S183 that the opening of the APC valve 22 is not equal to the target opening value (No in step S183), the vacuum pump controller 33 determines in step S195 whether or not the opening of the APC valve 22 is smaller than the target opening value. When the vacuum pump controller 33 determines that the opening of the APC valve 22 is larger than the target opening value (No in step S195), the vacuum pump controller 33 increases the rotation rate of the vacuum pump unit 30 by a predetermined rate. When the vacuum pump controller 33 determines that the opening of the APC valve 22 is smaller than the target opening value (Yes in step S195), the vacuum pump controller 33 reduces the rotation rate of the vacuum pump unit 30 by a predetermined rate. In this case, when the opening of the APC valve 22 is equal to the target opening value (Yes in step S183), the vacuum pump controller 33 stores the current rotation rate of the vacuum pump unit 30 as the minimum rotation rate necessary for the gas flow mode in step S186.

When a process shown in FIG. 11 proceeds from step S184, in which the rotation rate of the vacuum pump unit 30 is increased, to step S196, in which the rotation rate is reduced, the difference between the rotation rate before the reduction is carried out in step S196 and the rotation rate after the reduction is carried out in step S196 is smaller than the difference between the rotation rate before the increase is carried out in step S184 and the rotation rate after the increase is carried out in step S184. On the other hand, when the process shown in FIG. 11 proceeds from step S196, in which the rotation rate of the vacuum pump unit 30 is reduced, to step S184, in which the rotation rate is increased, the difference between the rotation rate before the increase is carried out in step S184 and the rotation rate after the increase is carried out in step S184 is smaller than the difference between the rotation rate before the reduction is carried out in step S196 and the rotation rate after the reduction is carried out in step S196. Thus, the opening of the APC valve 22 can converge to the target opening value.

In the present embodiment, the controller 24 and the vacuum pump controller 33 constitute a controller according to the present invention. The controller according to the present invention, however, may be a single controller.

In a first half of the auto-tuning mode shown in FIGS. 2 and 3, the vacuum pump controller 33 searches the minimum rotation rate necessary for the gas flow mode. In a second half of the auto-tuning mode shown in FIGS. 2 and 3, the vacuum pump controller 33 searches the minimum rotation rate necessary for the vacuum mode. On the other hand, the vacuum pump controller 33 searches the minimum rotation rate necessary for the vacuum mode in a first half of the auto-tuning mode shown in FIGS. 8 and 9, while the vacuum pump controller 33 searches the minimum rotation rate necessary for the gas flow mode in a second half of the auto-tuning mode shown in FIGS. 8 and 9. The vacuum pump controller 33 may be designed to separately search the minimum rotation rate necessary for the gas flow mode and the minimum rotation rate necessary for the vacuum mode. For example, the vacuum pump controller 33 may be designed to search the minimum rotation rate necessary for the gas flow mode in the same way as in the first half of the auto-tuning mode shown in FIG. 2 and the minimum rotation rate necessary for the vacuum mode in the same way as in the first half of the auto-tuning mode shown in FIG. 8.

### THIRD EMBODIMENT

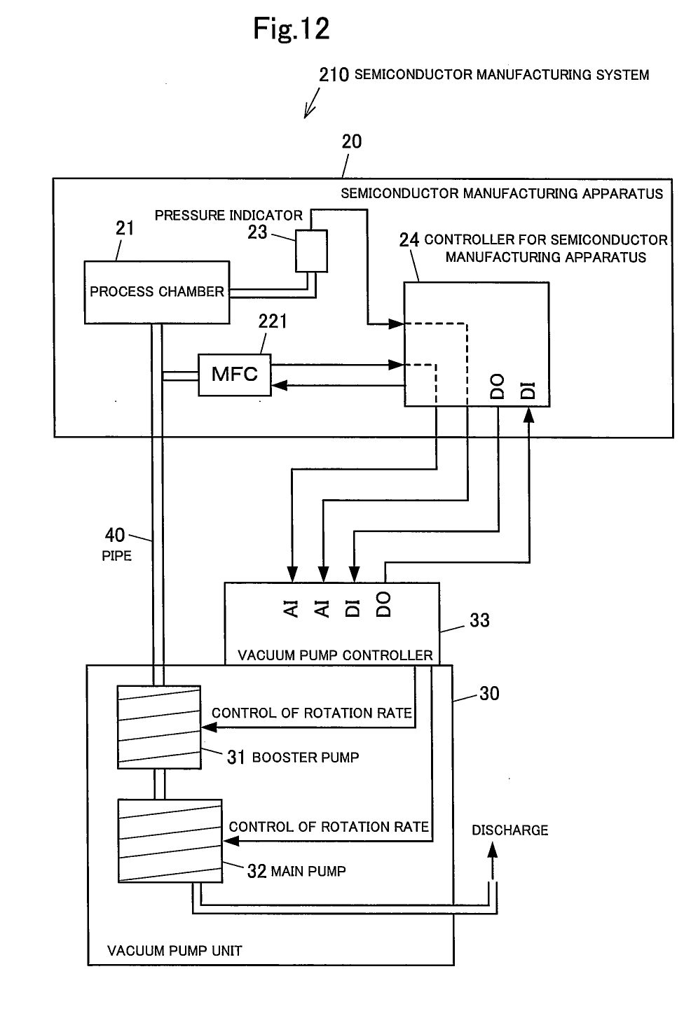

FIG. 12 is a diagram showing a vacuum system according to the third embodiment of the present invention.

The same elements of the vacuum system according to the third embodiment as those of the semiconductor manufacturing system 10 are denoted by the same reference numerals to thereby omit a description thereof.

FIG. 12 shows a semiconductor manufacturing system 210 as the vacuum system according to the present embodiment. The semiconductor manufacturing system 210 has a mass flow controller (MFC) 221 as means for controlling the flow rate of a gas in place of the APC valve 22 of the semiconductor manufacturing system 10 (see FIG. 1). The MFC 221 is designed to introduce a ballast gas into the pipe 40.

As the ballast gas, an inert gas such as He gas, Ar gas, and H₂ gas is preferably used. Especially, an inexpensive N₂ gas is more preferably used.

Next, operations of the semiconductor manufacturing system 210 will be described.

Each of the semiconductor manufacturing system 10 according to the first embodiment and the semiconductor manufacturing system according to the second embodiment is designed to use the APC valve 22 to control the pressure within the process chamber 21. The semiconductor manufacturing system 210 according to the third embodiment is designed to use the MFC 221 to control the amount of a ballast gas introduced into the pipe 40 and thereby control the pressure within the process chamber 21.

The state of the semiconductor manufacturing system 210 in which the MFC 221 is not set to introduce the ballast gas into the pipe 40 is corresponding to the state of the semiconductor manufacturing system 10 according to the first embodiment in which the opening of the APC valve 22 is 100% and the state of the semiconductor manufacturing system according to the second embodiment in which the opening of the APC valve 22 is 100%. In addition, the state of the semiconductor manufacturing system 210 in which the MFC 221 is set to introduce into the pipe 40 the ballast gas whose amount is the same as that suctioned by the vacuum pump unit 30 is corresponding to the state of the semiconductor manufacturing system 10 according to the first embodiment in which the opening of the APC valve 22 is 0% and the state of the semiconductor manufacturing system according to the second embodiment in which the opening of the APC valve 22 is 0%.

The operations of the semiconductor manufacturing system 210 are the same as those of the semiconductor manufacturing system 10 according to the first embodiment and the semiconductor manufacturing system according to the second embodiment except for the operations described above.

It is preferable that a target flow rate of a gas controlled by the MFC 221 (an operation rate of the MFC 221) in place of the target opening value be 20 to 30 slm (standard litter per minute (under temperature of 0° C. and at one atmosphere of pressure)) when an N₂ gas is used as the ballast gas.

The semiconductor manufacturing system 210 does not need to have the APC valve 22 provided with the pipe 40, differently from the semiconductor manufacturing system 10 according to the first embodiment and the semiconductor manufacturing system according to the second embodiment. The semiconductor manufacturing system 210, therefore, is capable of preventing a deterioration of conductance, which is caused by the APC valve 22.

### FOURTH EMBODIMENT

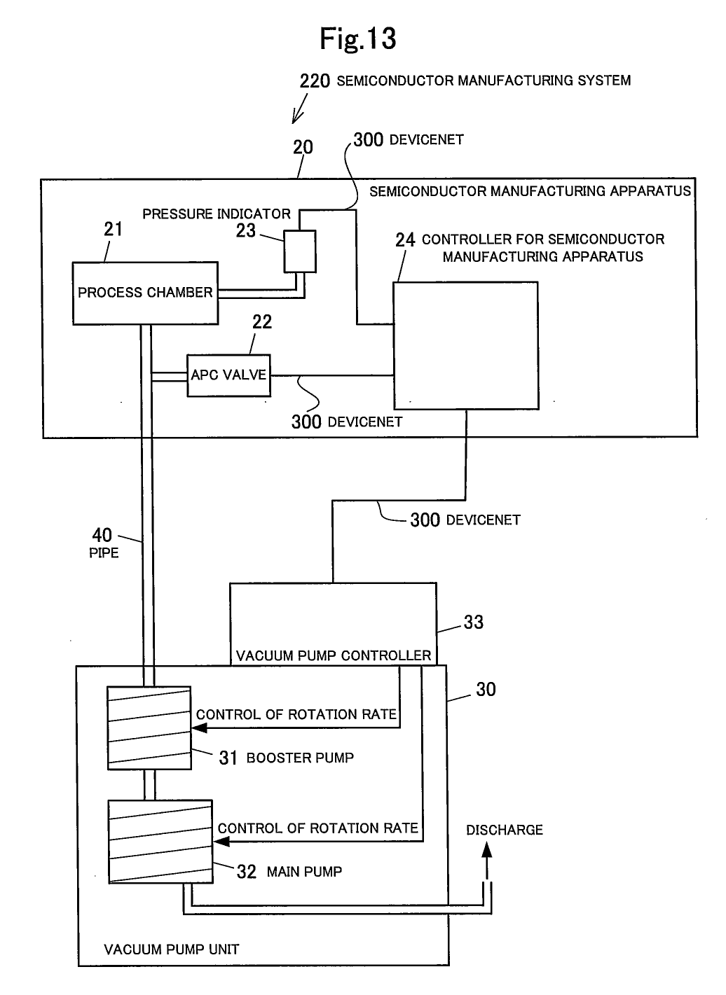

FIG. 13 is a diagram showing a vacuum system according to the fourth embodiment of the present invention.

The same elements of the vacuum system according to the fourth embodiment as those of the semiconductor manufacturing system according to the first embodiment are denoted by the same reference numerals to thereby omit description thereof.

In the first to third embodiments, the controller 24 and the vacuum pump controller 33 are synchronized with each other by use of a digital input/output signal in the semiconductor manufacturing system as the vacuum system. In addition, the controller 24 transmits, to the vacuum pump controller 33, the opening of the APC valve 22 (closing degree of the APC valve 22, which determines a flow rate of a gas) and a result of measurement performed by the pressure indicator 23 in an analog transmission scheme. In a semiconductor manufacturing system 220 as the vacuum system according to the fourth embodiment, a network connection such as DeviceNet 300, which is one of open field networks, is established between the indicator 23 and the controller 24, between the APC valve 22 and the controller 24, and between controller 24 and the vacuum pump controller 33.

DeviceNet is a communication link based on control area network (CAN) communications in accordance with ISO standard 11898 and allows connections using a line such as a input/output line, compensating lead wire, or RS232C, which results in wide spread use mainly in a factory automation field. DeviceNet uses CAN communication protocol for a part of physical layer and data link layer, and DeviceNet physical layer and application layer. On the CAN communication protocol, a data packet is exchanged. A device supporting DeviceNet has a device profile description file. Based on the description file, an address is allocated in a data area on the basis of the type of the device. DeviceNet, therefore, ensures compatibility with various devices. The DeviceNet 300 can be established as a wireless communication network by use of a wireless communication unit (a main and auxiliary devices, or a main device functioning as a controller for controlling a sequence of the entire system and an auxiliary device to be connected to the main device by wireless communications) supporting DeviceNet, the wireless communication unit being used for the vacuum pump controller 33 on the side of the vacuum pump unit 30 and for the pressure indicator 23, the APC valve 22, and the controller 24, which are controllers on the side of the semiconductor manufacturing apparatus 20.

In the present embodiment, each of input and output parts of the pressure indicator 23, the APC valve 22, and the controller 24, and input and output parts of the vacuum pump controller 33 functions as a connection unit having a FA connector standardized for DeviceNet. This allows the abovementioned analog signal and digital signal to be input and output.

The main operations of the semiconductor manufacturing system 220 according to the present embodiment are the same as the main operations of the semiconductor manufacturing system 10 according to the first embodiment except that DeviceNet is employed in the semiconductor manufacturing apparatus 20 and between the controller 24 and the vacuum pump controller 33 and that a packet is exchanged by use of a data area allocated on the basis of the controllers. The present embodiment, therefore, can obtain the same effect as the abovementioned embodiments. The network connection used in the present embodiment is not limited to DeviceNet.

The vacuum pump controller 33 of the vacuum system according to the first embodiment can function not only as means for determining whether or not the operation rate of the APC valve 22 (gas flow rate control means) is equal to the target opening value in step S76 of the auto-tuning mode shown in FIG. 2 but also as means for determining whether or not vacuum pressure within the process chamber 21 (vacuum chamber) can be maintained, since the vacuum pump controller 33 performs steps S77 and S78 when the opening of the APC valve 22 is not equal to the target opening value in step S76 and the vacuum pump controller 33 performs step S76 again. In this vacuum system, the vacuum pump controller 33 may function as means for detecting power and a current, which are consumed by the vacuum pump unit 30, at a predetermined time interval to determine whether or not the detected value is lower than a value which is previously detected.

The vacuum pump controller 33 may function as means for determining whether or not the temperature of the vacuum pump unit 30 is equal to or higher than (or lower than) a predetermined value by use of a temperature sensor provided in the vacuum pump unit 30 or existing temperature detecting means, the temperature sensor being designed to detect the temperature of the inside of the vacuum pump unit 30.

In the flowchart shown in FIG. 2, step S78 is may be followed by a step of determining whether or not each of power of and a current consumed by the vacuum pump unit 30, which are detected, is lower or higher than a value previously detected, and then the process may proceed to step S79 to store the minimum rotation rate necessary for the gas flow mode without proceeding to step S76 when the rotation rate of the vacuum pump unit 30 changes from its decreasing state to its increasing in order to maintain the pressure within the process chamber 21 to the target vacuum pressure necessary for the gas flow mode. Alternatively, step S78 of the flowchart shown in FIG. 2 may be followed by a step of determining whether or not the temperature of the vacuum pump unit 30 is equal to or higher than, or equal to or lower than a predetermined value with or without the abovementioned step which follows step S78, and then the process may proceed to step S79 to store the minimum rotation rate necessary for the gas flow mode without proceeding to step S76 when the temperature of the vacuum pump unit 30 reaches a predetermined value in order to maintain the pressure within the process chamber 21 to the target vacuum pressure necessary for the gas flow mode. The vacuum pump controller 33 or the controller 24 may be designed to perform the abovementioned steps. In the vacuum system thus constructed, the rotation rate of the vacuum pump unit 30 can be stored as the minimum rotation rate necessary for the gas flow mode, the rotation rate being obtained when the rotation rate changes from its decreasing state to its increasing state, under the condition that the pressure within the process chamber 21 is maintained to the target vacuum pressure necessary for the gas flow mode. The rotation rate of the vacuum pump unit 30, which is close to the minimum rotation rate necessary for the gas flow mode, can be obtained in advance, which contributes to energy conservation.

### INDUSTRIAL APPLICABILITY

As described above, the vacuum system according to the present invention can be provided with the vacuum pump operating at a more appropriate rotation rate compared with the conventional techniques when a predetermined process is carried out in the vacuum chamber. The vacuum system, therefore, can contribute to energy conservation and is useful as a system for forming a vacuum space in a vacuum chamber such as a process chamber for treating a semiconductor substrate in a device for manufacturing a semiconductor and a plasma treatment chamber for manufacturing a liquid crystal monitor, and other vacuum system.

1. A vacuum system comprising:
a vacuum pump for discharging a gas in a vacuum chamber;
gas flow rate control means for controlling a flow rate of said gas to be discharged; and
a controller for controlling an operation rate of said gas flow rate control means to control pressure within said vacuum chamber to vacuum pressure appropriate for a predetermined process, wherein
said controller has a gas flow mode as an operation mode for performing a predetermined process in said vacuum chamber and an auto-tuning mode for determining a rotation rate of said vacuum pump to set said operation rate of said gas flow rate control means to a target value lower by a predetermined value than the full operation rate of said gas flow rate control means under the condition that pressure within said vacuum chamber is set to vacuum pressure necessary for said gas flow mode, said auto-tuning mode being performed before said operation mode; and
said controller includes:
means for decreasing said rotation rate of said vacuum pump from a rated rotation rate under the condition that pressure within said vacuum chamber is set to vacuum pressure necessary for said gas flow mode, or increasing said rotation rate of said vacuum pump from a minimum rotation rate sufficient to maintain said vacuum pressure necessary for said gas flow mode, to determine whether or not said operation rate of said gas flow rate control means reaches said target value; and
means for storing, as a rotation rate of said vacuum pump in said gas flow mode, said rotation rate of said vacuum pump, which is obtained when it is determined that said operation rate of said gas flow rate control means reaches said target value.

2. A vacuum system as set forth in claim 1, wherein
said controller has a vacuum mode as an operation mode for maintaining pressure within said vacuum chamber to vacuum pressure lower than said vacuum pressure necessary for said gas flow mode under the condition that said gas flow rate control means is open, and
said controller includes:
determination means for determining whether or not pressure within said vacuum chamber can be maintained to high vacuum necessary for said vacuum mode in said auto-tuning mode under the condition that said vacuum pump operates at said stored rotation rate necessary for said gas flow mode;
means for increasing said rotation rate of said vacuum pump when said determination means determines that pressure within said vacuum chamber cannot be maintained to high vacuum necessary for said vacuum mode; and
means for storing, as a rotation rate of said vacuum pump in said vacuum mode, said rotation rate of said vacuum pump which is obtained when said determination means determines that pressure within said vacuum chamber can be maintained to high vacuum necessary for said vacuum mode.

3. A vacuum system comprising:
a vacuum pump for discharging a gas in a vacuum chamber;
gas flow rate control means for controlling a flow rate of said gas to be discharged; and
a controller for controlling an operation rate of said gas flow rate control means to control pressure within said vacuum chamber to vacuum pressure appropriate for a predetermined process, wherein
said controller has a gas flow mode as an operation mode for performing a predetermined process in said vacuum chamber, a vacuum mode as an operation mode for maintaining pressure within said vacuum chamber to vacuum pressure lower than said vacuum necessary for said gas flow mode under the condition that said gas flow rate control means is open, and an auto-tuning mode for determining said rotation rate of said vacuum pump to set pressure within said vacuum chamber to high vacuum necessary for said vacuum mode, said auto-tuning mode being performed before said operation modes, and
said controller includes:
determination means for decreasing said rotation rate of said vacuum pump from a rated rotation rate or increasing said rotation rate of said vacuum pump from a minimum operational rotation rate of said vacuum pump, in said auto-tuning mode, to determine whether or not pressure within said vacuum chamber reaches said high vacuum necessary for said vacuum mode; and
means for storing, as a rotation rate of said vacuum pump in said vacuum mode, said rotation rate of said vacuum pump, which is obtained when said determination means determines that pressure within said vacuum chamber reaches said high vacuum necessary for said vacuum mode.

4. A vacuum system as set forth in claim 3, wherein
said controller includes:
means for determining whether or not said operation rate of said gas flow rate control means is smaller than a target value set in advance in said auto-tuning mode under the condition that said vacuum pump operates at said stored rotation rate necessary for said vacuum mode to control said gas flow rate control means and to thereby set pressure within said vacuum chamber to said high vacuum necessary for said gas flow mode;
means for increasing said rotation rate of said vacuum pump when it is determined that said operation rate of said gas flow rate control means is smaller than said target value set in advance; and
means storing, as a rotation rate of said vacuum pump in said gas flow mode, said rotation rate of said vacuum pump which is obtained when it is determined that said operation rate of said gas flow rate control means is equal to or higher than said target value set in advance.

5. A vacuum system as set forth in claim 2, wherein
said controller causes said vacuum pump to operate in said operation mode at a higher one of said rotation rate necessary for said gas flow mode and said rotation rate necessary for said vacuum mode, said rotation rates being calculated in said auto-tuning mode.

6. A method for operating a vacuum system for discharging a vacuum chamber by use of a vacuum pump and controlling an operation rate of gas flow rate control means, which determines the flow rate of a gas, to control a flow rate of a gas and to thereby control pressure within said vacuum chamber to a predetermined value,
said vacuum system having an operation mode including a gas flow mode for performing a vacuum process in said vacuum chamber and an auto-tuning mode for determining a rotation rate of said vacuum pump in said operation mode, said auto-tuning mode being performed before said operation mode, wherein
said auto-tuning mode comprises the steps of:
setting a target value of pressure within said vacuum chamber for said gas flow mode and a target value of said operation rate of the gas flow rate control means;
increasing said rotation rate of said vacuum pump from a minimum rotation rate allowing pressure within said vacuum chamber to be maintained to said target value of pressure within said vacuum chamber for said gas flow mode or decreasing said rotation rate of said vacuum pump from a rated rotation rate;
determining whether or not said operation rate of said gas flow rate control means reaches said target value of said opening; and
storing a rotation rate of said vacuum pump, which is obtained when said operation rate of said gas flow rate control means reaches said target value of said operation rate.

7. A vacuum system as set forth in claim 1, further comprising:
means for determining whether or not vacuum pressure within said vacuum chamber can be maintained, and/or means for determining whether or not said operation rate of said gas flow rate control means reaches said target value of said operation rate;
at least one of means for determining whether or not power consumed by said vacuum pump is reduced, means for determining whether or not a current consumed by said vacuum pump is reduced, and means for determining whether or not a temperature of said vacuum pump is equal to or higher than a predetermined value, or equal to or lower than said predetermined value; and
means for storing, as a rotation rate of said vacuum pump in said gas flow mode or in said vacuum mode, said rotation of said vacuum pump, which is obtained based on determination of said at least one of said means.

8. A method for operating a vacuum system as set forth in claim 6, further comprising:
at least one of:
i) a step of determining whether or not pressure within said vacuum chamber is maintained to predetermined vacuum,
ii) a step of determining whether or not power consumed by said vacuum pump is reduced,
iii) step of determining whether or not a current consumed by said vacuum pump is reduced, and
iv) a step of determining whether or not a temperature of said vacuum pump is equal to or higher than a predetermined value or equal to or lower than said predetermined value; and
a step of storing, as a rotation rate of said vacuum pump in said gas flow mode or in said vacuum mode, said rotation rate of said vacuum pump, which is obtained based on determination of said at least one of steps.

9. A vacuum system as set forth in claim 4, wherein
said controller causes said vacuum pump to operate in said operation mode at a higher one of said rotation rate necessary for said gas flow mode and said rotation rate necessary for said vacuum mode, said rotation rates being calculated in said auto-tuning mode.

10. A vacuum system as set forth in claim 2, further comprising:
means for determining whether or not vacuum pressure within said vacuum chamber can be maintained, and/or means for determining whether or not said operation rate of said gas flow rate control means reaches said target value of said operation rate;
at least one of means for determining whether or not power consumed by said vacuum pump is reduced, means for determining whether or not a current consumed by said vacuum pump is reduced, and means for determining whether or not a temperature of said vacuum pump is equal to or higher than a predetermined value, or equal to or lower than said predetermined value; and
means for storing, as a rotation rate of said vacuum pump in said gas flow mode or in said vacuum mode, said rotation of said vacuum pump, which is obtained based on determination of said at least one of said means.

11. A vacuum system as set forth in claim 3, further comprising:
means for determining whether or not vacuum pressure within said vacuum chamber can be maintained, and/or means for determining whether or not said operation rate of said gas flow rate control means reaches said target value of said operation rate;
at least one of means for determining whether or not power consumed by said vacuum pump is reduced, means for determining whether or not a current consumed by said vacuum pump is reduced, and means for determining whether or not a temperature of said vacuum pump is equal to or higher than a predetermined value, or equal to or lower than said predetermined value; and
means for storing, as a rotation rate of said vacuum pump in said gas flow mode or in said vacuum mode, said rotation of said vacuum pump, which is obtained based on determination of said at least one of said means.

12. A vacuum system as set forth in claim 4, further comprising:
means for determining whether or not vacuum pressure within said vacuum chamber can be maintained, and/or means for determining whether or not said operation rate of said gas flow rate control means reaches said target value of said operation rate;
at least one of means for determining whether or not power consumed by said vacuum pump is reduced, means for determining whether or not a current consumed by said vacuum pump is reduced, and means for determining whether or not a temperature of said vacuum pump is equal to or higher than a predetermined value, or equal to or lower than said predetermined value; and
means for storing, as a rotation rate of said vacuum pump in said gas flow mode or in said vacuum mode, said rotation of said vacuum pump, which is obtained based on determination of said at least one of said means.

13. A vacuum system as set forth in claim 5, further comprising:
means for determining whether or not vacuum pressure within said vacuum chamber can be maintained, and/or means for determining whether or not said operation rate of said gas flow rate control means reaches said target value of said operation rate;
at least one of means for determining whether or not power consumed by said vacuum pump is reduced, means for determining whether or not a current consumed by said vacuum pump is reduced, and means for determining whether or not a temperature of said vacuum pump is equal to or higher than a predetermined value, or equal to or lower than said predetermined value; and
means for storing, as a rotation rate of said vacuum pump in said gas flow mode or in said vacuum mode, said rotation of said vacuum pump, which is obtained based on determination of said at least one of said means.
